(19) United States
(12) Patent Application Publication
(10) Pub. No.: US 2026/0187630 A1
(43) Pub. Date: Jul. 2, 2026

(54) SYSTEMS AND METHODS FOR SAME SCREEN GESTURE BASED INTERACTION WITH MULTIMEDIA CONTENT

(71) Applicant: The Giving Project, Sheridan, WY (US)

(72) Inventors: Jared Benjamin Wells, Friendswood, TX (US); Russel Michael Kuchta, Macungie, PA (US); David Logan Yarian, The Woodlands, TX (US)

(73) Assignee: The Giving Project, Sheridan, WY (US)

(21) Appl. No.: 19/437,114

(22) Filed: Dec. 30, 2025

Related U.S. Application Data
(60) Provisional application No. 63/740,838, filed on Dec. 31, 2024.

(51) Int. Cl. G06Q 20/38; G06Q 20/40

(52) U.S. Cl. CPC G06Q 20/389; G06Q 20/383; G06Q 20/401

(57) ABSTRACT

A method for managing transactions, the method that includes detecting a user interaction on visual content displayed on a digital display, identifying whether the user interaction occurred within a visual interactive area associated with a visual component of the visual content, or an audio interactive area associated with an auditory component of the visual content, selecting a beneficiary based on whether the user interaction occurred within the visual interactive area or the audio interactive area, generating a transaction in response to the user interaction, where the transaction is associated with a monetary value and the beneficiary, and displaying a visual confirmation on the digital display overlaid on the visual content.

### CROSS REFERENCE TO RELATED APPLICATIONS

This is a nonprovisional application claiming priority to 63/740,838, the entirety of which is incorporated by reference.

### FIELD OF INVENTION

The present disclosure relates to systems and methods to facilitate nonintrusive user interaction with multimedia content.

### BACKGROUND

Devices and/or components of devices are often capable of performing certain functionalities that other devices and/or components are not configured to perform and/or are not capable of performing. In such scenarios, it may be desirable to adapt one or more systems to enhance the functionalities of devices and/or components that cannot perform the one or more functionalities.

### BRIEF DESCRIPTION OF THE DRAWINGS

FIG. 1 is a diagram showing various computer devices and their connection to a network.

FIG. 2 is a diagram showing various data structures and data associated therewith.

FIG. 3 is a diagram showing a user consuming content on a user device.

FIG. 4A is a diagram showing example combined audio and visual content with a combined audio and visual interactive area.

FIG. 4B is a diagram showing example separate audio and visual content with separate audio and visual interactive areas.

FIG. 4C is a diagram showing multiple example visual contents with corresponding visual interactive areas, as well as a separate audio interactive area.

FIG. 4D is a diagram showing an example product interactive area.

FIG. 5 is a diagram showing user interaction with visual interactive area.

FIG. 6 is a diagram showing an example transaction dashboard.

FIG. 7 is a flowchart of a method for detecting user interaction, generating transactions, and confirmation of the user interaction.

FIG. 8 is a flowchart of a method for generating specific details of a transaction based on the user interaction.

FIG. 9 is a flowchart of a method for confirming or canceling transactions.

FIG. 10 is a flowchart of a method for publishing transaction data.

FIG. 11 is a flowchart of a method for scanning public transaction data and updating transactions data.

FIG. 12 is a diagram of an example computing environment.

FIG. 13A is a diagram of an example leaderboard.

FIG. 13B is a diagram of an example content/recipient/campaign leaderboard.

FIG. 13C is a diagram of an example campaign recipient leaderboard.

### DETAILED DESCRIPTION

### Overview and Advantages

A desire exists for users to interact with consumed content, particularly with digital content on various content platforms. Traditionally, users regularly engage with digital content across a multitude of platforms, including social media platforms, video hosting platforms, live streaming platforms, and community forums. Such content may be created by the host platform, another user, or a recognized influencer. However, this user engagement generally revolves around the consumption itself.

Traditionally, users consuming content are provided with limited means of expressing appreciation to content creators. Appreciation is conventionally expressed via a "like" gesture button, a tap on specific content, or a "follow" button for the creator. Some platforms may have a "tip" feature allowing content consumers to financially reward content creators. However, the execution and user experience of such buttons differ markedly from standard interactions. For example, a "tip" gesture is often used to provide content consumers the ability to financially reward creators, but such tips are typically limited to a single denomination or fixed amount. This limited interaction restricts the potential social value derived from these interactions.

Despite the substantial amounts of time users spend consuming digital content on technology platforms, users may be hesitant to engage financially with the content platform. Consequently, existing practices focus primarily on advertising value, causing host platforms and content creators to strive for audience retention as the primary means for compensation. And, although financially focused user interactions may exist outside of the platform, such interactions often necessitate leaving the content application entirely and stopping consumption altogether. Furthermore, existing transaction mechanisms usually require the user to first provide specific financial information, the intended recipient, the transaction purpose, and the amount. These interruptions, redirections, and mandatory informational inputs may lead to friction in the user experience and user disengagement.

As disclosed in one or more embodiments herein, a system is provided to allow a user to trigger a transaction, such as a pledge, with a simple user gesture without leaving the content platform. That is, this gesture may be performed without leaving the screen where the content is being consumed, thereby providing an uninterrupted content consumption experience. The transaction is initiated without a button click, and the consumption or viewing of the content continues without interruption.

By integrating the financial interaction seamlessly with the content consumption experience, resistance to financial transactions may be reduced. Further reduction in resistance is achieved by using micropayments, such as $0.01 or $0.05, to minimize a user's monetary concerns with the transaction. The transaction is initiated without requiring the user to first provide specific information about the intended recipient or purpose. For example, the user is not asked to provide additional information, such as the amount or date, nor are they prompted to confirm the transaction at that moment (the transaction may be added to a queue for later confirmation).

The beneficiary is determined automatically by the system based on predefined logic. For pledges, the beneficiary may be identified based on predetermined selections by the content consumer or the content creator. If neither the content user nor the creator has identified a beneficiary, the pledge may be allocated based on system-wide historical averages or other data. This methodology provides the user with a quick and frictionless transaction without interrupting the consumption of content.

Unlike conventional linear gestures, the gesture in the disclosed system is non-linear in form and is unbounded. In one or more embodiments, the more the gesture is repeated in quick succession, the more the user pledges. Repeated gestures at a given time may result in a geometric increase in pledge amounts. This approach allows content to be appreciated with differing intensity. For example, while one gesture may equate to a $0.01 pledge, multiple repetitions separated by a specific interval may allow each instance to correspond to an additional $0.01 pledge. Alternatively, successive gestures within a defined time window may increase the pledged amount geometrically, where sets of gestures equate to higher amounts.

Distinctions between pledge amounts may also be determined by implementing more than one type of gesture. For instance, a double tap could equate to a $0.01 pledge, while a three-finger stroke may equate to a $0.05 pledge. Machine learning or artificial intelligence may be employed to modulate the pledge amount based on variables such as user history, social media presence, or creditworthiness.

The disclosed system is designed to reduce user resistance to financial engagement by shifting the perception of the transaction from profit-based to giving-based. Users are encouraged to support content creators by engaging with a preferred charity or supporting the creator directly. Financial engagements may be made non-binding through the use of a "pledge".

Furthermore, the system may utilize a public charity support organization structure wherein tax benefits are provided in the form of charitable donation receipts issued by a registered charitable organization. Donations may be consolidated and distributed to charities selected by users or content creators. A weekly subscription or "front-loaded account" model may be used to settle pledges, encouraging small weekly payments.

Transactional data, such as settled pledges and donations, is recorded in a blockchain to provide greater trust, transparency, and accountability. Tools may be provided to each user to decode and search their transactional history on the blockchain. This integration of blockchain technology ensures the integrity and immutability of the data stored. Users are effectively provided with the ability to convey appreciation by donating to a charity, sending a financial gift, purchasing a product, or reacting to a poll. Engagement is elevated from a superficial gesture to a pledge gesture that can provide real-world monetary impact.

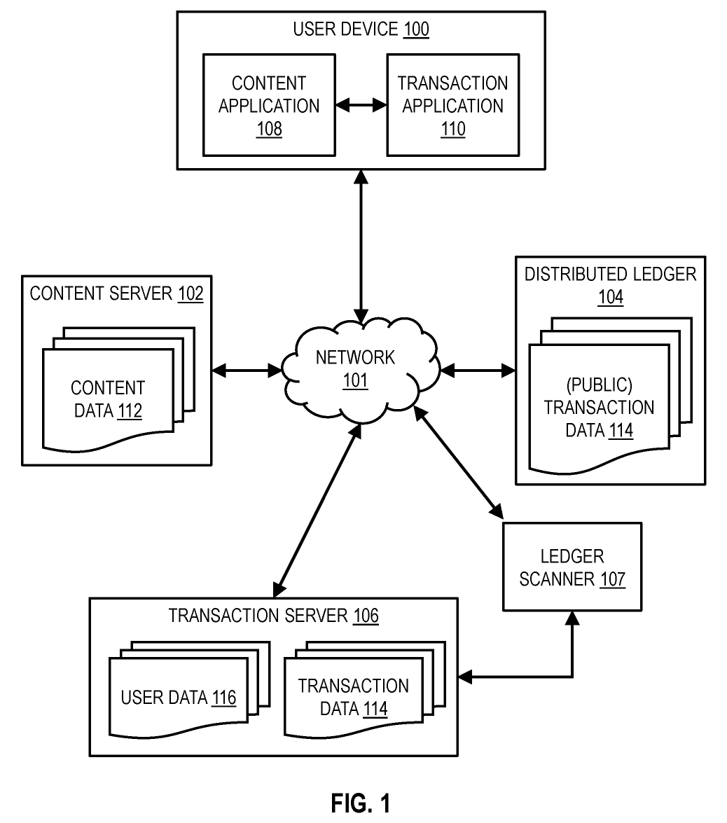

### FIG. 1

FIG. 1 is a diagram showing various computer devices and their connection to a network.

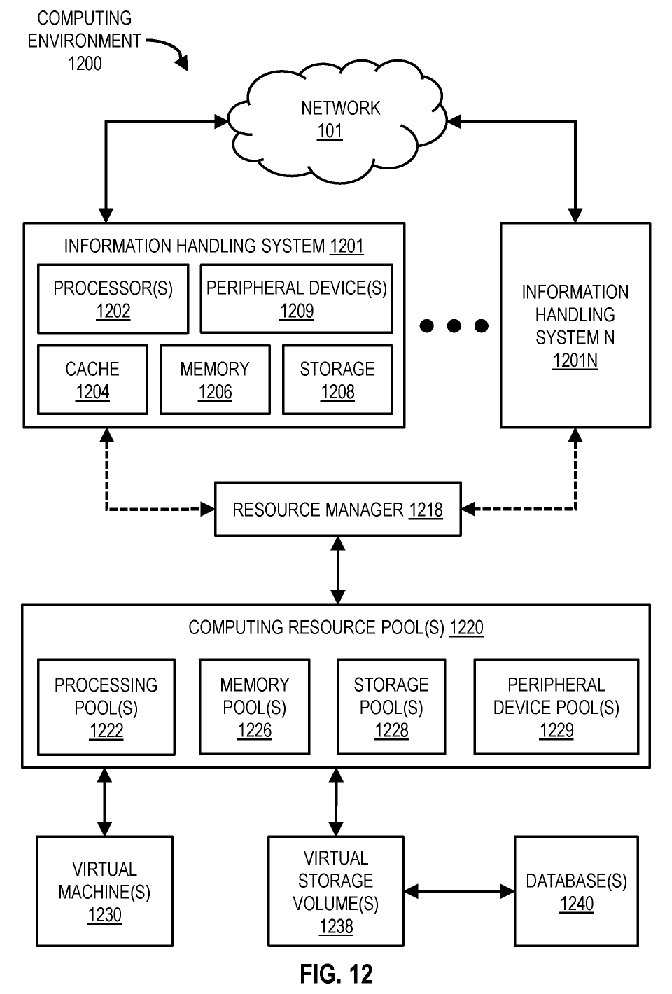

User device 100 is an information handling system (see description in FIG. 12). User device 100 may be utilized by user 350 to consume digital content 244. User device 100 may include content application 108 and transaction application 110 installed thereon, operatively connected via network 101 to content server 102, transaction server 106, and distributed ledger 104. User device 100 can be any form of client device capable of accessing wide area networks, such as a mobile device, a laptop, a desktop, a smartphone, a tablet, or a wearable device. User device 100 is depicted as a mobile phone in the figures as a non-limiting example. User device 100 may further include a digital display 352 and a speaker 354 to present visual and auditory content to user 350. User device 100 may be configured with an antenna to communicate with a technology platform.

Network 101 is a collection of connected information handling systems (e.g., 1201, 1201N) which allows for the exchange of data and/or the sharing of computing resources therebetween. Non-limiting examples of network 101 include a local area network (LAN), a wide area network (WAN) (e.g., the Internet), a mobile network, any combination thereof, and any other type of network which allows for the communication of data and sharing of resources among computing devices operatively connected thereto. A person of ordinary skill in the relevant art, having the benefit of this detailed description, would appreciate that a network is a collection of operatively connected computing devices which enables communication between those computing devices.

Content server 102 is a server system (one or more information handling systems 1201) configured to host and serve digital content (content data 112). Content server 102 may be any major content platform which provides content data 112 (over network 101) to content application 108 (on user device 100) for consumption by user 350. Content server 102 may be operatively connected to transaction server 106 and distributed ledger 104 via network 101. Content server 102 may utilize a Content Delivery Network (CDN) to efficiently serve content data 112.

Distributed ledger 104 is a system that utilizes a decentralized, distributed, and public digital ledger to record transactions. Distributed ledger 104 may be used to record transaction data 114 across many computers, servers, and nodes so that the record cannot be altered retroactively without the alteration of all subsequent blocks and the consensus of the distributed ledger network, facilitating the integrity and immutability of the data stored on distributed ledger 104. Distributed ledger 104 may be used for publicly recording transaction data 114 to provide greater trust, transparency, and accountability to all participants. Distributed ledger 104 may utilize utility tokens, such as a "give coin" or "gift coin," which may be denominated in common currency (e.g., United States dollars) for the transaction amounts, where the tokens are used for tracking and transparency purposes and do not hold inherent value themselves. Distributed ledger 104 may be operatively connected to user device 100, content server 102, transaction server 106, and ledger scanner 107 via network 101. Ledger scanner 107 may monitor and analyze data on distributed ledger 104 in real-time. A non-limiting example of distributed ledger 104 is a blockchain ledger.

Transaction server 106 is a server system (one or more information handling systems 1201) that processes and manages transaction-related functions. Transaction server 106 may include one or more data components such as user data 116 and transaction data 114. Transaction server 106 may include (or otherwise communicate with) ledger scanner 107. Transaction server 106 may communicate with transaction application 110 on user device 100 via network 101. Transaction server 106 may be configured to automatically trigger settlement processes when specific conditions are met, such as reaching a predefined transaction threshold or on a periodic basis (e.g., daily, weekly). Transaction server 106 may receive confirmed transaction data 114 from user device 100 and propagate data to distributed ledger 104. Transaction server 106 may save all of the transaction information, like a "shopping cart", and only send the total transaction amount to the payment processor.

Ledger scanner 107 is a component of a server system (e.g., transaction server 106 and/or standalone) configured to monitor and analyze blockchain data in real-time. Ledger scanner 107 may perform real-time data processing, event detection, data parsing, filtering, and aggregation. Ledger scanner 107 may monitor distributed ledger 104 to detect new transaction entries and to populate and update leaderboards. Ledger scanner 107 may check if the transaction metadata is relevant to the system. If relevant, the data may be sent to a queue system to be stored in transaction server 106. As a non-limiting example, ledger scanner 107 may process transaction data 114 (from distributed ledger 104) and determine if those transactions should be stored in a database system for further usage by any other element of the embodiment.

Content application 108 is software executing on user device 100 which facilitates the consumption of digital content. Content application 108 may be a host application or website where user 350 is browsing or consuming content. Content application 108 may access content data 112 served from content server 102. Content application 108 may provide content data 112 to user 350 via digital display 352 (as visual content 244V) and/or speaker 354 (as auditory content 244A). Content application 108 may be bootstrapped or embedded on a content site or social media platform. Content application 108 may work in conjunction with transaction application 110 on user device 100 to enable user interaction with the content, such as performing a single-action gesture for a transaction, without interrupting the user's consumption of the content.

Transaction application 110 is software executing on user device 100 which facilitates user interaction 562 with content 244 and transaction-related activities. Transaction application 110 may operate in conjunction with content application 108 to detect and respond to user interactions 562, such as a gesture for initiating a transaction. Transaction application 110 may communicate with transaction server 106 via network 101 to send and receive transaction data 114. Transaction application 110 may be configured to generate pending transaction dashboard 670 (e.g., a shopping cart or queue) where transactions are accumulated until the user 350 confirms or cancels them. Transaction application 110 may receive and store transaction data 114 and may further be capable of interacting with a payment processor to facilitate the settlement of confirmed transactions.

Content data 112 is digital information (data) representing multimedia, text, or interactive material served to a computing device for consumption by user 350. Content data 112 may include various forms of media, such as video files, audio tracks, live streams, text articles, static images, virtual reality environments, augmented reality overlays, or any combination thereof. Content data 112 may comprise specific content 244, content identifier 224, recipient identifier 246, campaign identifier 248, and any associated metadata. Content data 112 may be transmitted from content server 102 to content application 108 on user device 100 via network 101. Content data 112 may be parsed or analyzed to define specific interactive boundaries, such as visual interactive area 460V or audio interactive area 460A, which allow a user to trigger transactions through gestures performed on the screen. Content data 112 may further include timestamps or object tracking data to associate specific moments or physical items within a video stream with purchasing or tipping opportunities.

Transaction data 114 is digital information (data) representing the details of a value exchange, pledge, donation, or commercial interaction initiated by a user within a computing environment. Transaction data 114 may comprise a plurality of data fields including, but not limited to, timestamp 218, transaction identifier 220, user identifier 222, content identifier 224, amount 226, campaign identifier 248, and any associated metadata. Transaction data 114 may further include status indicators, such as processed flag 228, recorded flag 230, and anonymity flag 232, which are used to track the settlement status and privacy preferences associated with a specific interaction. Transaction data 114 may be generated by transaction application 110 residing on user device 100 following a detected user interaction 562 and subsequently transmitted to transaction server 106 via network 101. Transaction data 114 may be stored in a temporary state, such as within a pending transaction dashboard 670, prior to being committed for settlement. Transaction data 114 may be recorded on distributed ledger 104 to provide an immutable and transparent history of interactions, potentially utilizing utility tokens for tracking purposes. Transaction data 114 may be parsed by ledger scanner 107 to update leaderboards or generate analytical reports regarding content engagement and charitable contributions. Transaction data 114 may represent aggregated financial totals sent to a payment processor while simultaneously representing granular splits of funds between content creators, platforms, and charities for internal accounting or blockchain recording. As used herein, a singular "transaction" refers to a single instance of transaction data 114, and multiple (two or more) "transactions" refer to multiple (two or more) instances of transaction data 114.

User data 116 is digital information (data) identifying and characterizing a specific individual (e.g., user 350) or entity authorized to interact with a transaction system. User data 116 may include a plurality of data fields, such as user identifier 222, payment information 234, device identifier(s) 236, and transaction identifier(s) 220, which collectively facilitate the authentication and processing of financial exchanges. User data 116 may further comprise settings 238, which store configurable preferences including minimum contacts 240 required to trigger a gesture and initial amount 242 designated for a default transaction value. User data 116 may be stored within transaction server 106 and accessed to verify a user's identity or retrieve stored credit card credentials during a checkout or settlement process. User data 116 may include privacy preferences 243 that determine whether a user's identity remains anonymous or is publicly displayed on a leaderboard (by setting anonymity flag 232). User data 116 may also store historical usage data, such as a cumulative record of pledges, donations, or tips given to various content creators or charities.

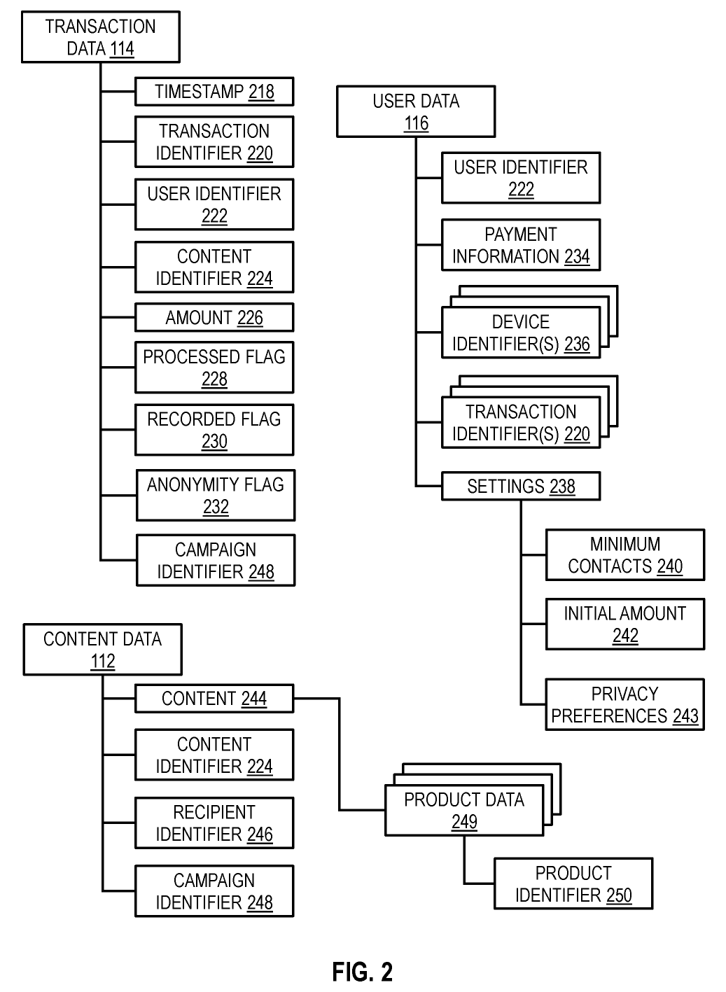

### FIG. 2

FIG. 2 is a diagram showing various data structures and data associated therewith.

Timestamp 218 is data which specifies a point in time. Timestamp 218 may specify the year, month, day, hour, minute, and/or second in numerical form (e.g., "2023-07-23T22:44:32Z" in ISO 8601 format indicating July 23, 2023 at 10:44:32pm Coordinated Universal Time (UTC)). This time may be an offset from a common point in the past (i.e., 0 AD). Timestamp 218 may specify additional smaller increments of time (e.g., centi-seconds, milliseconds, etc.) and/or a time zone (e.g., "Eastern Standard Time" (EST), "Central Daylight Time" (CDT), "Paris", etc.) indicating an offset from a presumed time zone (UTC). In one or more embodiments, timestamp 218 may measure time from a known offset other than year 0 AD (e.g., "Unix time" is measured as the cumulative sum of elapsed seconds since midnight January 1, 1970 UTC). One of ordinary skill in the art, having the benefit of this detailed description, would appreciate that timestamp 218 may be any alpha, numeric, or alphanumeric expression that indicates a date, time, offset, or any combination thereof.

An identifier, generally, is information that identifies an associated entity (e.g., data, one or more physical objects, etc.). An identifier may be encoded in a digital format (i.e., data) and/or physical format, for example by printing, stamping, and/or engraving a physical object. Such physical representations of an identifier may be human and/or machine readable (e.g., alphanumeric plaintext, universal product code (UPC) barcode, quick-response (QR) code, etc.). A digital representation of an identifier may include an integer count or index (e.g., 0, 1, 2, 3, 4, 5, etc.), a timestamp, alphanumeric text which may be descriptive of the associated entity (e.g., "jdoe-profile_550108", "sales-east-2025-Q1-450825"), and/or pseudo-random characters (e.g., a "universally unique identifier" (UUID)). An identifier may be generated by one or more software components of the system and/or by a user of one or more systems disclosed herein. Non-limiting examples of an identifier (stored as data) include a tag, an alphanumeric string, a filename, a row number in a table, an internet protocol (IP) address, a stock keeping unit (SKU) number, a model number, a serial number, and any other suitable data to identify a single entity (or group of entities with a shared property).

Transaction identifier 220 is an identifier associated with a specific financial exchange, pledge, or interaction event. Transaction identifier 220 may be generated by transaction application 110 or transaction server 106 upon the creation of transaction data 114 following a detected user interaction 562.

User identifier 222 is an identifier associated with a specific user 350 and/or account of user 350. User identifier 222 may be generated by content application 108, content server 102, transaction application 110, or transaction server 106 upon the creation of the user's account.

Content identifier 224 is an identifier associated with specific content 244. Content identifier 224 may be generated by content application 108 or content server 102 upon the content creator uploading the specific content 244 to content server 102. Further, content identifier 224 may be generated by transaction application 110 or transaction server 106 for separate reference to the specific content 244.

Amount 226 is digital data representing a monetary value, a quantity of currency, or a unit of value assigned to a financial interaction initiated by user 350. Amount 226 may be stored within transaction data 114 and associated with transaction identifier 220 to quantify the specific value of a pledge, tip, donation, or commercial purchase. Amount 226 may be initially determined based on a default value configured in settings 238, such as a micropayment of one cent per gesture. Amount 226 may be dynamically calculated based on the frequency or intensity of user interactions, where successive gestures performed within a specific time window result in a geometric increase in the value recorded. Amount 226 may be determined by the specific type of gesture performed, such as a two-finger tap corresponding to a first value and a three-finger stroke corresponding to a second, higher value. Amount 226 may be modulated by machine learning algorithms that analyze user history, social media presence, or creditworthiness to suggest or set an optimal transaction size. Amount 226 may be edited or customized by a user within transaction dashboard 670 prior to the final commitment of the transaction. Amount 226 may represent a total sum that is subsequently divided into smaller allocations for a content creator, a charitable beneficiary, and a platform fee. Amount 226 may be denominated in a fiat currency, such as United States dollars, or represented by a utility token on distributed ledger 104.

Processed flag 228 is a digital status indicator, boolean value, or data field utilized to track the settlement or completion state of a specific financial interaction initiated by user 350. Processed flag 228 may be stored within transaction data 114 alongside other metadata, such as transaction identifier 220 and amount 226, to distinguish between tentative pledges and finalized financial events. Processed flag 228 may be initially set to a "pending" or false state when a transaction is generated via a gesture and added to transaction dashboard 670, thereby designating the interaction as an uncommitted item within a queue or shopping cart. Processed flag 228 may be subsequently updated to a "processed" or true state once user 350 explicitly confirms the transaction and the necessary financial data is successfully transmitted to, and accepted by, transaction server 106 or an external payment processor. Processed flag 228 may be queried by transaction application 110 to determine which transactions should be removed from the pending view (transaction dashboard 670) and archived in a history log. Processed flag 228 may further function as a gatekeeping mechanism for backend processes, by ensuring only fully settled transactions are aggregated for financial reporting or forwarded to ledger scanner 107 for leaderboard updates. Processed flag 228 may operate in conjunction with recorded flag 230 to provide a granular status update, differentiating between the financial settlement of funds and the immutable recording of the event on distributed ledger 104.

Recorded flag 230 is a digital status indicator, Boolean value, or metadata field configured to track the archival status of a specific transaction. Recorded flag 230 may be stored as a component of transaction data 114 and utilized to confirm that a specific pledge or donation initiated by user 350 has been immutably preserved on distributed ledger 104. Recorded flag 230 may be set to a positive value or "true" state only after ledger scanner 107 or a similar verification module detects the presence of the transaction on the blockchain and validates the entry against internal records. Recorded flag 230 may function to differentiate between the financial settlement of a transaction (indicated by processed flag 228) and the public transparency of that transaction. Thus, recorded flag 230 may act to ensure that funds are not only transferred but also publicly acknowledged. Recorded flag 230 may be queried during the generation of leaderboards to ensure that only verified, publicly committed transactions are displayed to the community. Recorded flag 230 may also be used by transaction server 106 to trigger a retry mechanism or alert if a financial exchange has occurred but the corresponding transparency record has not yet been successfully confirmed on the network.

Anonymity flag 232 is a digital status indicator, Boolean value, or data field utilized to determine the visibility of a user's identity in public records or displays. Anonymity flag 232 may be stored within transaction data 114. Anonymity flag 232 may be set based on privacy preferences 243 selected by user 350 within user data 116. Anonymity flag 232 may function to toggle the display of user identifier 222 between a public state and an obscured state on a leaderboard generated by ledger scanner 107. Anonymity flag 232 may be processed by transaction server 106 to ensure that specific details regarding a pledge or donation are recorded on distributed ledger 104 without revealing the personal identity of the donor. Anonymity flag 232 may allow user 350 to participate in transparent giving ecosystems while maintaining control over their personal data exposure.

Payment information 234 is a collection of secure data credentials, tokenized financial details, and/or banking references required to execute a monetary transfer. Payment information 234 may be stored within user data 116 and utilized to facilitate the settlement of financial exchanges triggered by user interaction 562. Payment information 234 may include credit card numbers, bank account details, or digital wallet tokens necessary for a payment processor to capture funds. Payment information 234 may be retrieved by transaction server 106 during a checkout process or when a threshold of pending transactions is reached. Payment information 234 may be provided by user 350 prior to a content consumption session or upon the confirmation of accumulated pledges in transaction dashboard 670. Payment information 234 may be processed securely to convert a pledge gesture into a realized financial donation or payment.

Device identifier 236 is a unique string of characters, numbers, or data assigned to a specific hardware device utilized by user 350 (e.g., user device 100). Device identifier 236 may be stored within user data 116 to associate a specific user device 100 with an account held by user 350. Device identifier 236 may be an existing identifier for the hardware or may be generated during the installation or execution of content application 108 or transaction application 110. Device identifier 236 may be utilized by transaction server 106 to authenticate incoming transaction requests originating from user device 100. Device identifier(s) 236 may allow the system to distinguish between gestures performed on different hardware form factors, such as a mobile phone versus a tablet, which may influence how user interaction 562 is detected or interpreted.

Settings 238 is a collection of user-configurable parameters, preferences, and rules that govern the behavior of the transaction system. Settings 238 may be stored within user data 116 and accessed by transaction application 110 to interpret user interaction 562. Settings 238 may comprise specific variables such as minimum contacts 240 and initial amount 242. Settings 238 may allow user 350 to define the sensitivity of a gesture or the default monetary value associated with a single interaction. Settings 238 may be adjusted to customize the user experience, allowing for personalized transaction behaviors. Further, settings 238 may guard against unintended transactions, reducing the likelihood that accidental touches are interpreted as financial pledges.

Minimum contacts 240 is a numerical value or parameter defining the requisite number of simultaneous touch points required to validate a user gesture. Minimum contacts 240 may be stored within settings 238 as part of user data 116. Minimum contacts 240 may be utilized by transaction application 110 to distinguish between standard navigation inputs and a specific user interaction 562 intended to trigger a transaction. Minimum contacts 240 may be configured to require, for example, a two-finger tap or a three-finger stroke to initiate a pledge. Minimum contacts 240 may be adjusted by user 350 to prevent inadvertent activation of the transaction mechanism during normal handling of user device 100.

Initial amount 242 is a predefined monetary value, currency unit, or token quantity assigned to a single instance of a user gesture. Initial amount 242 may be stored within settings 238 and designated as the default transaction value for a new interaction. Initial amount 242 may be set to a micropayment value, such as $0.01 or $0.05, to minimize resistance to financial engagement. However, user 350 may set initial amount 242 to a higher value matching their comfort level (e.g., $1, $5, $100, etc.). Initial amount 242 may serve as a baseline value which may be subsequently increased based on the repetition or frequency of the gesture (e.g., linearly, geometrically, exponentially, etc.). Initial amount 242 may be referenced by transaction application 110 when generating transaction data 114 following a detected user interaction 562.

Privacy preferences 243 is a set of user-defined rules or selections regarding the disclosure of personal identity in association with financial activities. Privacy preferences 243 may be included in user data 116. Privacy preferences 243 may be utilized to determine the state of anonymity flag 232 within transaction data 114. Privacy preferences 243 may dictate whether the identity of user 350 is publicly displayed on a leaderboard or recorded transparently on distributed ledger 104. Privacy preferences 243 may allow user 350 to participate in charitable giving while maintaining confidentiality regarding their specific contributions.

Content 244 is the specific digital media, payload, or interactive material presented to a user for consumption. Content 244 may be a component of content data 112 transmitted from content server 102. Content 244 may be rendered on user device 100 as visual content 244V displayed on digital display 352 or auditory content 244A output via speaker 354. Content 244 may include video files, live streams, audio tracks, or text articles. Content 244 may be associated with specific metadata, such as content identifier 224, to link the media with a specific creator or transaction opportunity. Content 244 may serve as the visual or auditory canvas upon which user interaction 562 is performed.

Recipient identifier 246 is an identifier associated with the intended beneficiary of a financial transaction for the specific content 244. Recipient identifier 246 may be included within content data 112. Recipient identifier 246 may specify a content creator, a charitable organization, or a specific cause selected to receive funds from a pledge. Recipient identifier 246 may be utilized by transaction server 106 to allocate funds correctly when user 350 performs user interaction 562 on content 244 (interactive area 460). Recipient identifier 246 may be determined automatically based on logic defined by the content creator if no specific beneficiary is pre-selected.

Campaign identifier 248 is an identifier associated with a piece of content with a specific fundraising event, marketing drive, or time-limited cause. Campaign identifier 248 may be included as metadata within content data 112 and transaction data 114. Campaign identifier 248 may be utilized to aggregate transactions generated across multiple pieces of content 244 that are part of a unified effort. Campaign identifier 248 may allow transaction server 106 to track the progress of a specific fundraising goal or to apply special logic to pledges made during a specific event window. Campaign identifier 248 may be used to generate specialized leaderboards or reports dedicated to a particular charitable initiative or creator event.

Product data 249 is a collection of digital metadata, commercial specifications, and spatiotemporal coordinates associated with a purchasable item embedded within a digital media stream. Product data 249 may be stored as a component of content data 112 (and/or content 244) residing on content server 102 and transmitted to user device 100 via network 101. Product data 249 may comprise specific attributes defining the terms of a commercial transaction, including a fixed monetary price, a vendor reference, and a textual product description. Product data 249 may further include object tracking information, such as timestamped coordinate maps generated by artificial intelligence, which define the dynamic boundaries of a distinct interactive region (e.g., product interactive area 460P) as the object moves across digital display 352. Product data 249 may be accessed by transaction application 110 upon detection of user interaction 562 to determine if the input coordinates correspond to a tracked object. Consequently, product data 249 may be utilized to override standard pledge logic, ensuring that transaction data 114 reflects the specific fixed price of the item selected by user 350 rather than a variable geometric donation amount.

Product identifier 250 is an identifier associated with a specific commercial item available for purchase within content 244. Product identifier 250 may be stored within product data 249 and associated with specific content data 112. Product identifier 250 may function similarly to a Stock Keeping Unit (SKU) or a Universal Product Code (UPC) to distinguish a particular object, such as a specific article of clothing or merchandise, from other interactive elements displayed on digital display 352. Product identifier 250 may be captured by transaction application 110 when user interaction 562 is detected within the boundaries of a tracked object. Subsequently, product identifier 250 may be included in transaction data 114 to ensure that the resulting financial settlement is correctly attributed to the specific vendor and item selected by user 350, facilitating accurate inventory management and fulfillment.

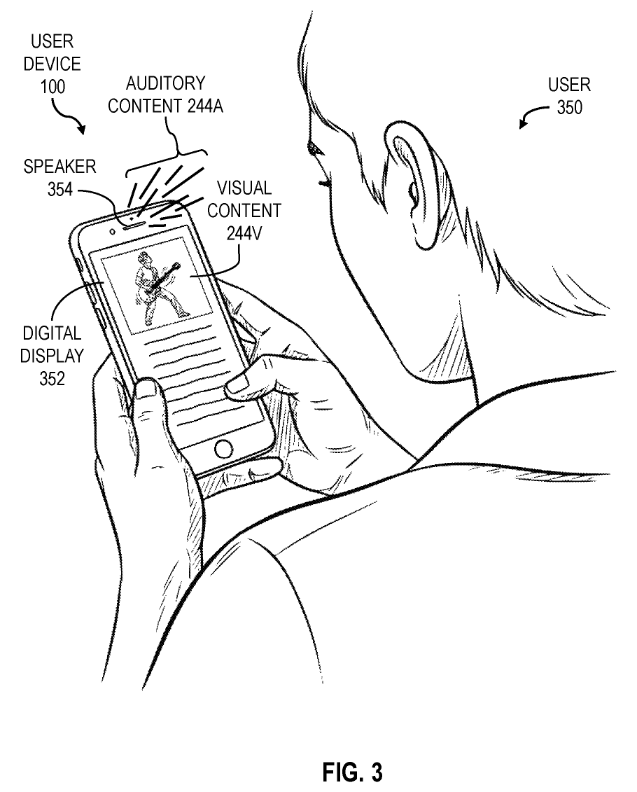

### FIG. 3

FIG. 3 is a diagram showing a user consuming content on a user device.

User 350 is an individual, entity, or automated agent utilizing user device 100 to engage with digital media and financial systems. User 350 may interact with content application 108 to consume content data 112 served by content server 102. Further, user 350 may perform user interaction 562, such as a multi-touch gesture, on digital display 352 to initiate a transaction without interrupting the consumption of content 244. User 350 may be associated with user data 116, which may comprise user identifier 222, payment information 234, and settings 238. Additionally, user 350 may configure privacy preferences 243 to control whether user identifier 222 is displayed on a public leaderboard or recorded anonymously on distributed ledger 104. User 350 may review, confirm, or cancel pending transactions within transaction dashboard 670 prior to the settlement of funds. User 350 may be authenticated by transaction server 106 to authorize payments or to link historical transaction data 114 to a specific profile.

Digital display 352 is an electrical device which generates a visual output. One or more digital displays 352 may be disposed on and/or around user device 100. Digital display 352 may be touch sensitive to allow user 350 to interact with user device 100. Digital display 352 may provide visual content 244V to user 350. Further, digital display 352 may provide audio interactive area 460A and visual interactive area 460V, which allows user 350 to interact with auditory content 244A and visual content 244V, respectively.

Speaker 354 is an electrical device which generates sound waves. One or more speakers 354 may be disposed on and/or around user device 100. Further, speaker 354 may be used to provide auditory content 244A to user 350.

Auditory content 244A is a type of content 244, which may be a component of digital media comprising audio data configured to be processed and output as sound by a computing device. Auditory content 244A may be transmitted via network 101 as a portion of content data 112 and received by content application 108 residing on user device 100. Auditory content 244A may be output to user 350 through speaker 354, headphones, or other audio peripheral devices operatively connected to user device 100. Auditory content 244A may comprise various audio formats, including music tracks, podcasts, spoken dialogue, live streams, or sound effects. Auditory content 244A may be associated with a specific creator or beneficiary distinct from visual content 244V, allowing user 350 to direct a transaction specifically to the creator of the audio portion of a multimedia presentation. Auditory content 244A may correspond to audio interactive area 460A on digital display 352, providing a specific region for user interaction 562 targeting the audio stream. Auditory content 244A may be synchronized with visual content 244V or played independently. Auditory content 244A may be associated with a different content identifier 224 than one associated with visual content 244V. As such, content identifier 224 for auditory content 244A may be used by transaction server 106 to link user interaction 562 with specific segments of audio for accurate beneficiary determination.

Visual content 244V is a type of content 244, which may be a subset of digital media data comprising graphical, optical, or textual information configured for presentation on a display screen. Visual content 244V may be rendered on digital display 352 of user device 100 as a visible component of content data 112 served by content server 102. Visual content 244V may include various formats, such as video files, live streams, static images, text articles, or augmented reality overlays. Visual content 244V may be spatially aligned with visual interactive area 460V to define a specific region wherein user interaction 562 is detected and interpreted as a request for a transaction. Visual content 244V may be presented simultaneously with, yet independently from, auditory content 244A, allowing distinct transactions to be targeted toward creators of different media elements within a single presentation (e.g., using visual interactive area 460V). Visual content 244V may contain identifiable objects or regions tracked via metadata or artificial intelligence, enabling user 350 to tap specific items within a video stream to initiate a purchase or pledge. Visual content 244V may be associated with specific content identifier 224, which may be separate from the content identifier 224 for auditory content 244A. As such, there may be a distinct recipient identifier 246 to facilitate the correct allocation of funds derived from user interaction 562 performed over the visual media.

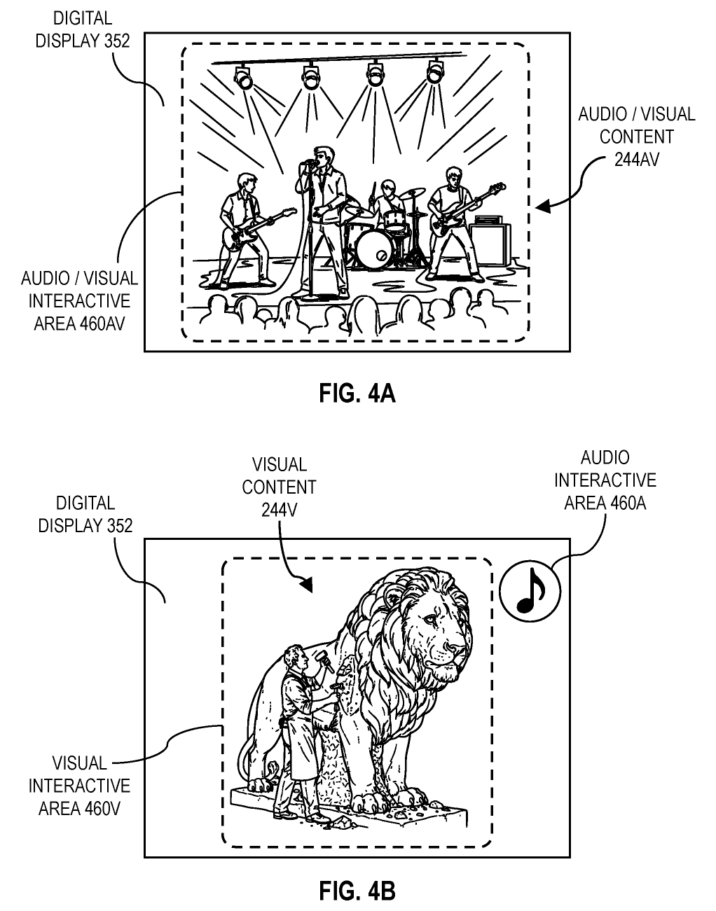

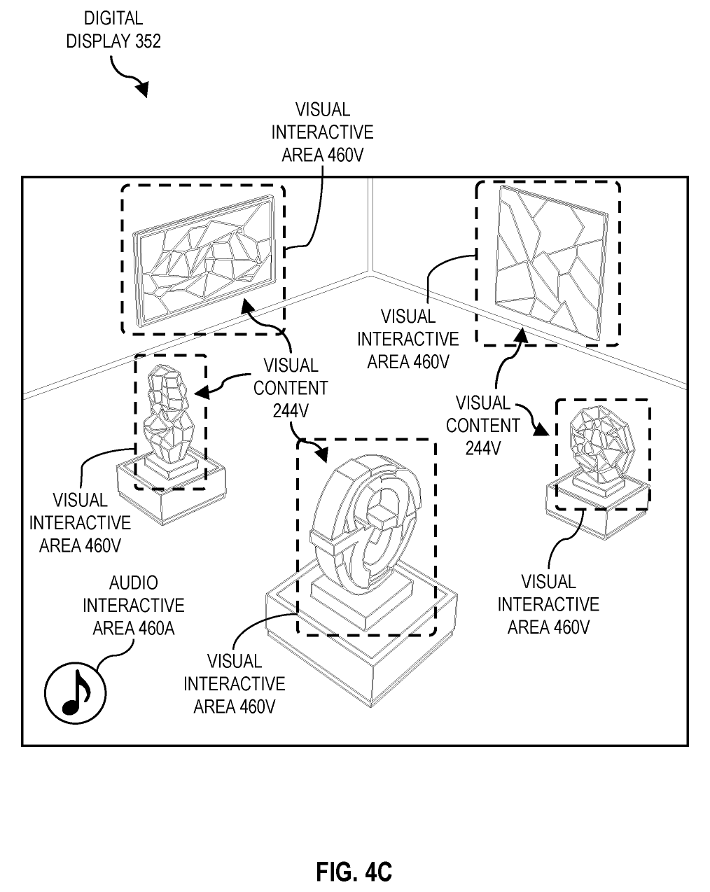

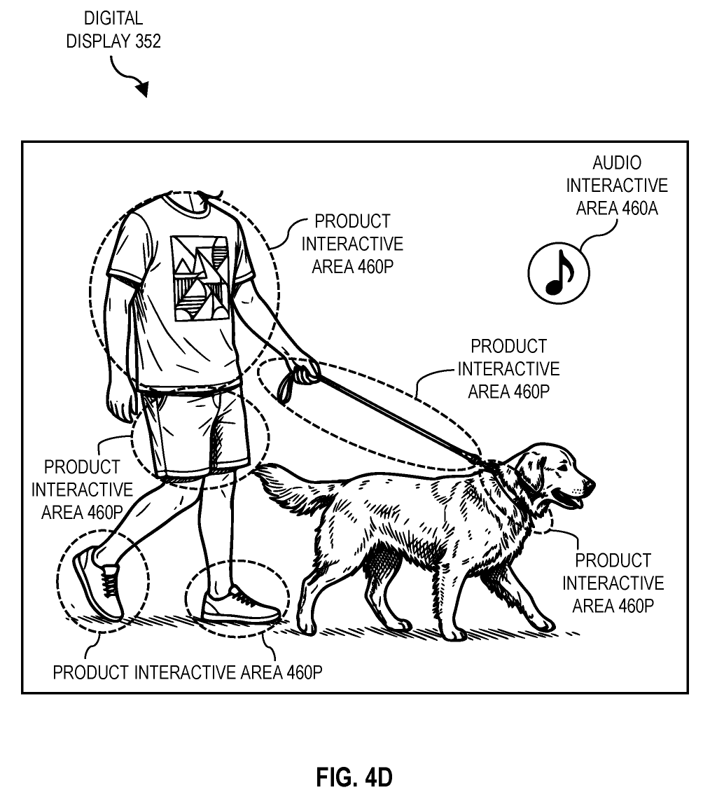

### FIGS. 4A-4D

FIG. 4A is a diagram showing example combined audio and visual content with a combined audio and visual interactive area. FIG. 4B is a diagram showing example separate audio and visual content with separate audio and visual interactive areas. FIG. 4C is a diagram showing multiple example visual contents with corresponding visual interactive areas, as well as a separate audio interactive area. FIG. 4D is a diagram showing an example product interactive area.

Audio interactive area 460A is a designated portion, overlay, or interactive element rendered on digital display 352 configured to receive input from user 350 targeting auditory content 244A. Audio interactive area 460A may be spatially distinct from visual interactive area 460V to facilitate separate engagement with the audio components of a multimedia presentation. Audio interactive area 460A may appear as a specific icon, such as a musical note, overlaying content 244 or positioned within a peripheral region of digital display 352. Audio interactive area 460A may detect user interaction 562, such as a tap, multi-touch input, or gesture, and trigger transaction application 110 to generate transaction data 114 specifically associated with the creator or beneficiary linked to auditory content 244A. Audio interactive area 460A may enable user 350 to support a musical artist or podcaster independently of the creator responsible for the accompanying visual content 244V. Audio interactive area 460A may provide visual feedback (e.g., visual confirmation 564), such as an animation or color change, upon the successful registration of user interaction 562 within the defined boundaries.

Visual interactive area 460V is a designated zone, boundary, or portion of digital display 352 configured to receive inputs targeting specific graphical elements. Visual interactive area 460V may enable user 350 to perform user interaction 562, such as a multi-touch gesture, directly upon visual content 244V to trigger a financial or interactive event. Visual interactive area 460V may be superimposed over the entirety of a video or image, or visual interactive area 460V may be defined around discrete objects, products, or regions within the content, such as individual paintings or statues within a virtual room. Visual interactive area 460V may be spatially distinct from audio interactive area 460A, allowing user 350 to selectively engage with the visual aspects of a presentation independently from the auditory track. Visual interactive area 460V may be dynamic, wherein the boundaries of visual interactive area 460V track the movement of an object, such as a specific merchandise item or article of clothing, across digital display 352 during media playback. Visual interactive area 460V may facilitate the association of user interaction 562 with specific metadata, such as recipient identifier 246 or product pricing, linked to the precise location of the gesture. Visual interactive area 460V may provide visual feedback (e.g., visual confirmation 564), such as an animation or color change, upon the successful registration of user interaction 562 within the defined boundaries.

Product interactive area 460P is a designated zone, dynamic boundary, or interactive overlay rendered on digital display 352 configured to track and receive inputs targeting a specific purchasable object displayed within visual content 244V. Product interactive area 460P may be generated via artificial intelligence algorithms or metadata tagging that timestamps and maps the screen coordinates of a specific item, such as a piece of clothing, a prop, or merchandise, as the item moves across digital display 352. Product interactive area 460P may function independently of visual interactive area 460V. Consequently, user interaction 562 detected within the boundaries of product interactive area 460P may trigger a distinct commercial purchase event (e.g., "add to cart") rather than a general pledge or tip associated with the broader visual content 244V. Product interactive area 460P may be associated with specific product data 249 and product identifier 250 to facilitate that the resulting transaction data 114 reflects the correct fixed price and item description associated with the selected object.

As depicted in FIG. 4A, auditory content 244A and visual content 244V may be combined as audio/visual content 244AV on digital display 352. Consequently, there is a single combined audio/visual interactive area 460AV. This may occur if the originator of the visual data and the originator of the auditory data are the same entity (e.g., a musical concert performance). Consequently, audio/visual interactive area 460AV may be depicted as a single, unified region overlapping audio/visual content 244AV. Within FIG. 4A, a gesture or input received within audio/visual interactive area 460AV may be processed as a single transaction directed to the common creator. Audio/visual interactive area 460AV may encompass the entire display region devoted to the playback of audio/visual content 244AV.

As depicted in FIG. 4B, visual content 244V and auditory content 244A may be separate distinct media streams originating from different creators. For example, visual content 244V may present a video of an artist sculpting, while auditory content 244A may present a musical track from a separate musician. Accordingly, digital display 352 may provide separate interactive regions to facilitate distinct transactions for each media type. Visual interactive area 460V may be defined over visual content 244V to receive user interaction 562 directed specifically toward the creator of the visual media. Simultaneously, audio interactive area 460A may be displayed as a separate icon or region on digital display 352 to receive user interaction 562 directed specifically toward the creator of the auditory media. This configuration allows transaction application 110 to parse user interaction 562 based on the specific location of the gesture, ensuring the transaction is associated with the correct recipient identifier 246.

As depicted in FIG. 4C, digital display 352 may render a plurality of distinct visual content 244V elements simultaneously. For example, visual content 244V may comprise multiple distinct art pieces displayed within a gallery environment or specific items tracked within a video frame. Each individual instance of visual content 244V may be bounded by or associated with a dedicated visual interactive area 460V. This granular configuration enables user 350 to perform user interaction 562 upon a specific item to direct a transaction to that particular object or its specific creator, rather than the collective scene. Additionally, audio interactive area 460A may be provided as a separate region on digital display 352. Audio interactive area 460A allows for interaction with auditory content 244A independent of the multiple distinct visual targets.

As depicted in FIG. 4D, digital display 352 may render visual content 244V containing specific objects designated for commercial interaction. Product interactive area 460P may be defined around discrete, identifiable items displayed within the media stream. For example, product interactive area 460P may be superimposed over specific merchandise appearing in a video, such as a t-shirt, a pair of shorts, a pair of shoes, a dog leash, and a dog collar. Each distinct instance of product interactive area 460P may be tracked dynamically via artificial intelligence or metadata tagging as the associated object moves across digital display 352. User interaction 562 received within the boundaries of product interactive area 460P may be interpreted by transaction application 110 as a request to purchase or view details regarding the specific item (e.g., the dog leash) rather than a general pledge to the content creator. Product interactive area 460P may be linked to specific product data 249 and product identifier 250, ensuring that the correct price and vendor information are retrieved for the selected item. Furthermore, audio interactive area 460A may be presented simultaneously to allow for continued interaction with auditory content 244A.

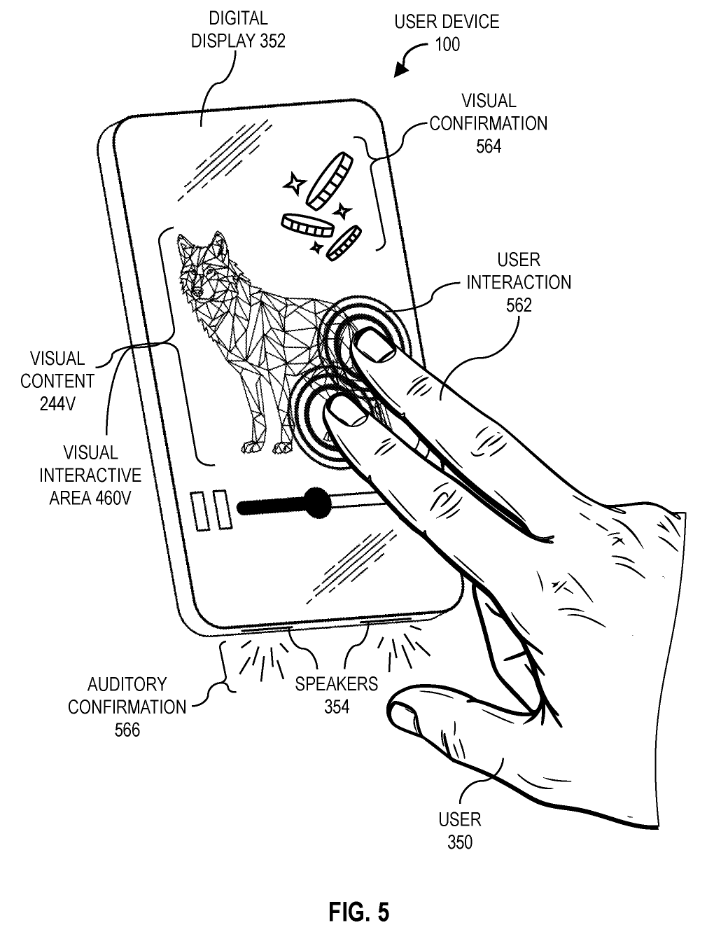

### FIG. 5

FIG. 5 is a diagram showing user interaction with visual interactive area.

User interaction 562 is a physical or logical input event detected by information handling system 1201 serving as a trigger for a specific command or function. User interaction 562 may consist of a specific gesture performed by user 350, such as a multi-finger tap, a swipe, or a stroke, on digital display 352. User interaction 562 may be spatially coordinated with content 244, specifically occurring within visual interactive area 460V or audio interactive area 460A to target a specific beneficiary or media element. User interaction 562 may be detected by transaction application 110 and distinguished from standard navigation inputs based on parameters defined in settings 238, such as minimum contacts 240. User interaction 562 may initiate the generation of transaction data 114, such as a pledge or donation, without interrupting the consumption of content data 112. User interaction 562 may be repeated in succession, whereby the frequency, intensity, and/or quantity of contacts of the input determines the value of amount 226 recorded for the transaction.

Visual confirmation 564 is a graphical object, animation, or overlay rendered on digital display 352 in response to a detected input event. Visual confirmation 564 may provide immediate feedback to user 350 indicating that user interaction 562 has been successfully registered by transaction application 110. Visual confirmation 564 may include various aesthetic representations, such as animated coins, sparkles, confetti, specific currency symbols, and/or any other representation that a transaction has been queued. Visual confirmation 564 may be dynamic in nature, altering its appearance based on the frequency, intensity, or context of user interaction 562. As successive gestures are performed and amount 226 increases, visual confirmation 564 may change in size, type, or quantity (e.g., shifting from a copper penny to a gold coin, or from a single coin to a pile of coins) to visually represent the accumulating value of the transaction. Visual confirmation 564 may be superimposed over content 244 and configured to disappear automatically, thereby confirming the action without interrupting the consumption of the media.

Auditory confirmation 566 is an audio signal, sound effect, or acoustic feedback mechanism generated by information handling system 1201 in response to a detected input event. Auditory confirmation 566 may be output via speaker 354 (e.g., on user device 100) to provide sensory acknowledgement that user interaction 562 has been successfully registered. Auditory confirmation 566 may be synchronized with visual confirmation 564 to create a cohesive feedback experience. For example, a specific sound, such as a coin "ding" or a viola strum, may be selected to match the thematic elements of visual confirmation 564 (e.g., coins or sparkles). Auditory confirmation 566 may be configured to remain silent to avoid interrupting or obscuring auditory content 244A during consumption. The specific sound, volume, or mute status of auditory confirmation 566 may be controlled by user 350 through parameters defined in settings 238.

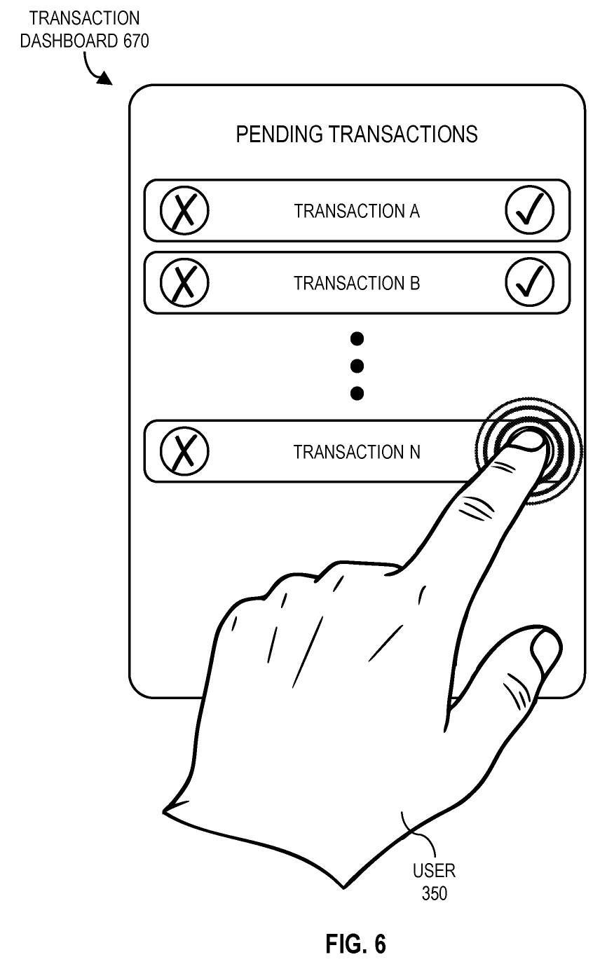

### FIG. 6

FIG. 6 is a diagram showing an example transaction dashboard.

Transaction dashboard 670 is a graphical user interface component, overlay, or dedicated screen configured to present a collected list of uncommitted financial interactions initiated by user 350. Transaction dashboard 670 may be generated by transaction application 110 and rendered on digital display 352 to function as a "shopping cart" or holding queue for accumulated pledges. Transaction dashboard 670 may display a plurality of rows or list items, each corresponding to distinct transaction data 114 generated during a content consumption session. Transaction dashboard 670 may allow these items to remain in a pending state, as indicated by processed flag 228, until further action is taken. Transaction dashboard 670 may comprise specific interactive digital regions, such as buttons, configured to receive inputs for confirming or canceling specific transactions. Furthermore, transaction dashboard 670 may be configured to detect directional gestures, such as a swipe left or a swipe right performed on a specific row, to execute confirmation or cancellation commands. Transaction dashboard 670 may further provide tools for user 350 to manually edit amount 226 associated with a pending transaction prior to final submission.

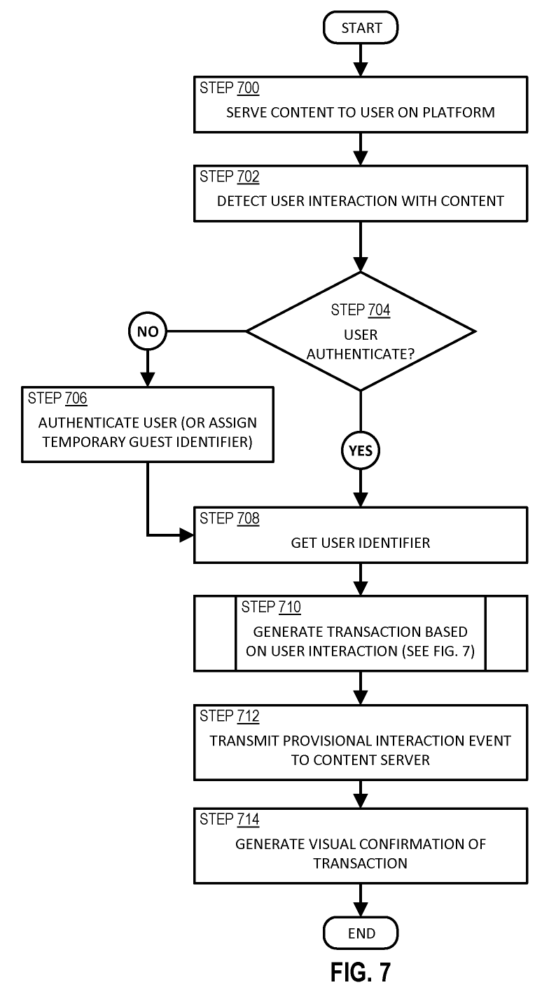

### FIG. 7

FIG. 7 is a flowchart of a method for detecting user interaction, generating transactions, and confirmation of the user interaction. All or a portion of the method in this flowchart shown may be performed by one or more components of information handling system 1201 or a user thereof. While the various steps in this flowchart are presented and described sequentially, a person of ordinary skill in the relevant art (having the benefit of this detailed description) would appreciate that some or all steps may be executed in different orders, combined, or omitted, and some or all steps may be executed in parallel.

In Step 700, content is served to user 350 on a technology platform. Content application 108 may request and receive content data 112 from content server 102 via network 101 for presentation on user device 100. Content data 112 may be rendered as visual content 244V on digital display 352 and/or output as auditory content 244A via speaker 354. This step may involve the initialization of an overlay or background script associated with transaction application 110, which monitors the consumption session without interfering with the playback or display of the primary media. The content served may include embedded metadata, such as content identifier 224 or product data 249, which defines specific interactive zones like visual interactive area 460V or product interactive area 460P.

In Step 702, user interaction 562 with content 244 is detected by transaction application 110. Transaction application 110 may monitor digital display 352 for specific input events, such as a single-action gesture, a tap, a swipe, or a multi-touch contact. The detected input may be compared against settings 238, specifically minimum contacts 240, to distinguish between intended transactional gestures and standard navigation commands (e.g., scrolling or pausing). The specific coordinates of user interaction 562 may be captured to determine if the input occurred within visual interactive area 460V, audio interactive area 460A, or product interactive area 460P. This detection process occurs in real-time while user 350 continues to consume content data 112.

In Step 704, a determination is made as to whether user 350 is currently authenticated within the system. Transaction application 110 may query local storage, session cookies, or user data 116 to verify if a valid user identifier 222 is active for the current session.

If a determination is made that user 350 is not authenticated (Step 704-NO), then the method proceeds to Step 706. However, if a determination is made that user 350 is authenticated (Step 704-YES), then the method proceeds to Step 708.

In Step 706, user 350 is authenticated or assigned a temporary guest identifier. Transaction application 110 may prompt user 350 to log in using existing credentials stored in user data 116. Alternatively, to reduce friction and maintain an uninterrupted viewing experience, transaction application 110 may automatically generate a temporary or "guest" version of user identifier 222. This temporary identifier allows the system to attribute subsequent user interaction 562 and resulting transaction data 114 to a provisional account, which may be reconciled or merged with a permanent profile at a later stage (e.g., during final settlement). Accordingly, unauthenticated users can still engage with the content immediately.

In Step 708, user identifier 222 is retrieved for association with the pending transaction. Transaction application 110 may access the active session data, whether it is a fully authenticated profile or the temporary guest ID generated in the previous step. This unique alphanumeric string is utilized to link the generated transaction data 114 to specific user 350, facilitating that the pledge, donation, or purchase is correctly billed and recorded in historical logs. User identifier 222 may also be used to retrieve associated privacy preferences 243 to determine if anonymity flag 232 should be set for the upcoming interaction.

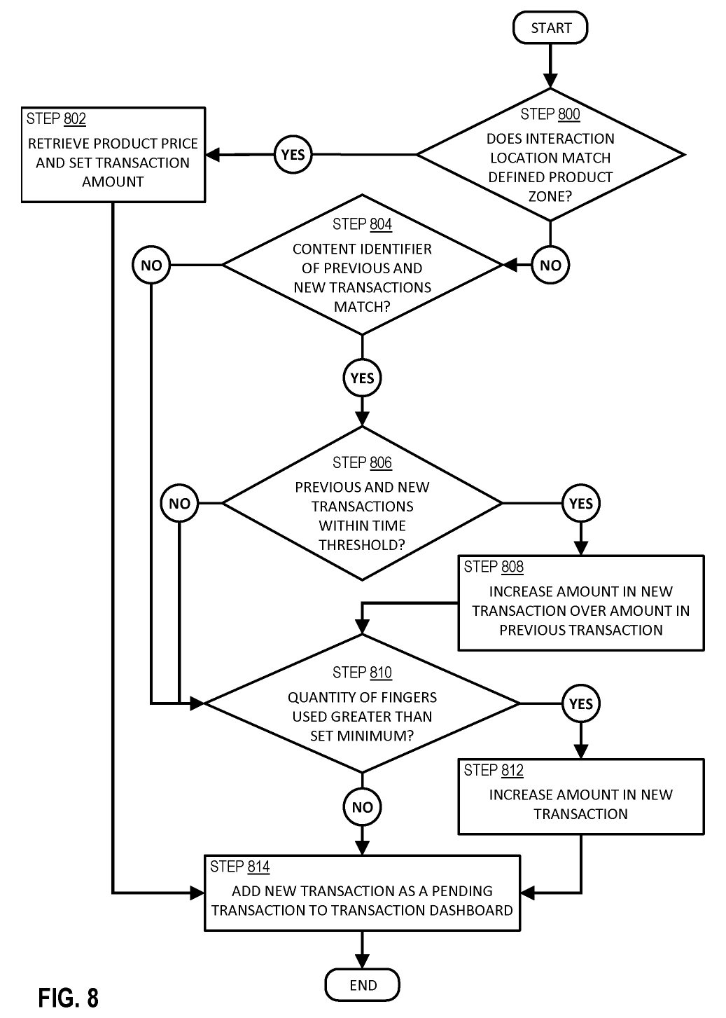

In Step 710, transaction data 114 is generated based on the characteristics of the detected user interaction 562. Transaction application 110 may execute a sub-process (as detailed further in the description of FIG. 8) to determine the specific nature of the financial event. This may involve calculating amount 226 based on gesture frequency, identifying a specific product identifier 250 based on screen coordinates, or determining the appropriate recipient identifier 246. The result of this step is the creation of a structured data object representing the pledge, tip, or "add-to-cart" event, which is then stored locally in a queue or transaction dashboard 670 pending final confirmation.

In Step 712, a provisional interaction event is transmitted to content server 102. Transaction application 110 may send a lightweight data packet or signal via network 101 indicating that user interaction 562 has occurred. This transmission may allow content server 102 to provide real-time feedback to the content creator (e.g., "User X just tipped!"), thereby encouraging further engagement during live streams. Additionally, in embodiments where the content is a live stream, content server 102 may be configured to broadcast a visualization signal to a session group comprising a plurality of other devices 100 consuming the same content. Upon receiving this signal, the content application 108 on the other devices 100 may generate a visual overlay (e.g., an icon, animation, or 'pop-up') substantially simultaneously the occurrence of visual confirmation 564 on user device 100. This shared visualization informs the audience of the contribution in real-time. This step may occur asynchronously and independently of the financial settlement process, allowing the social aspect of the interaction to be communicated immediately even if the financial component (transaction data 114) remains in a pending or uncommitted state within transaction dashboard 670.

In Step 714, visual confirmation 564 is generated and displayed on digital display 352. Transaction application 110 may render a graphical overlay, such as an animated coin, sparkle, or product icon, at the location of user interaction 562 or elsewhere on the screen. This feedback provides immediate sensory acknowledgement to user 350 that the gesture was successfully registered and that transaction data 114 has been queued. Additionally, auditory confirmation 566 may be output via speaker 354 if enabled in settings 238. The visual confirmation disappears automatically to minimize obstruction of content 244.

### FIG. 8

FIG. 8 is a flowchart of a method for generating specific details of a transaction based on the user interaction. All or a portion of the method in this flowchart shown may be performed by one or more components of information handling system 1201 or a user thereof. While the various steps in this flowchart are presented and described sequentially, a person of ordinary skill in the relevant art (having the benefit of this detailed description) would appreciate that some or all steps may be executed in different orders, combined, or omitted, and some or all steps may be executed in parallel.

In Step 800, a determination is made as to whether the specific screen coordinates of user interaction 562 correspond to the boundaries of product interactive area 460P. Transaction application 110 may compare the input location against metadata or object tracking maps provided within product data 249. This step allows the system to distinguish between a general gesture of appreciation (e.g., a tip) and a specific intent to engage commercially with a distinct object displayed on digital display 352.

If a determination is made that the interaction location matches a defined product zone (Step 800-YES), then the method proceeds to Step 802. Otherwise, if a determination is made that the interaction location does not match a defined product zone (Step 800-NO), then the method proceeds to Step 804.

In Step 802, product price is retrieved and utilized to set transaction amount 226. Transaction application 110 may access product data 249 associated with the identified product interactive area 460P to obtain the fixed monetary value or price of the selected item. Consequently, amount 226 for the generated transaction data 114 is set to this specific fixed value, overriding any default pledge settings. Additionally, product identifier 250 may be retrieved to link the transaction to the specific vendor inventory. The method then proceeds to Step 814.

In Step 804, a determination is made as to whether content identifier 224 associated with the current interaction matches content identifier 224 of an immediately preceding transaction. Transaction application 110 examines the most recent entry in transaction dashboard 670 or a temporary cache to see if user 350 is interacting with the same media stream consecutively. This check helps establish context for potential geometric scaling of the pledge amount.

If a determination is made that the content identifiers match (Step 804-YES), then the method proceeds to Step 806. Otherwise, if a determination is made that the content identifiers do not match (Step 804-NO), indicating a new context, then the method proceeds to Step 810.

In Step 806, a determination is made as to whether the current transaction and the previous transaction occurred within a specific time threshold. Transaction application 110 compares timestamp 218 of the current event against timestamp 218 of the previous event. This threshold (e.g., 2 seconds) helps determine if user 350 is "spamming" the gesture to show intense appreciation in a short burst, which may trigger a bonus multiplier.

If a determination is made that the transactions are within the time threshold (Step 806-YES), then the method proceeds to Step 808. Otherwise, if a determination is made that the time elapsed exceeds the threshold (Step 806-NO), then the method proceeds to Step 810.

In Step 808, amount 226 for the new transaction is increased relative to amount 226 of the previous transaction. Transaction application 110 may apply a multiplier, geometric progression, or linear addition to the value based on the sequence of rapid gestures. For example, a third rapid tap may result in a higher pledge value than the first two. This variable pricing mechanism allows user 350 to express heightened enthusiasm through rapid interaction. The method then proceeds to Step 810.

In Step 810, a determination is made as to whether the quantity of contacts detected during user interaction 562 exceeds minimum contacts 240 defined in settings 238. Transaction application 110 analyzes the touch input to see if user 350 utilized extra fingers (e.g., a three-finger tap instead of a two-finger tap). This allows for distinct tiers of giving based on the complexity of the gesture itself.

If a determination is made that the quantity of fingers used is greater than the set minimum (Step 810-YES), then the method proceeds to Step 812. Otherwise, if a determination is made that the quantity of fingers matches the minimum (Step 810-NO), then the method proceeds to Step 814.

In Step 812, amount 226 for the new transaction is increased based on the specific gesture type. Transaction application 110 may assign a higher tier value to complex gestures involving more contact points (e.g., a three-finger tap is valued at $0.05 whereas a two-finger tap is valued at $0.01). This allows user 350 to manually select a higher pledge tier for a single interaction without needing rapid repetition.

In Step 814, the newly generated transaction is added as a pending transaction to transaction dashboard 670. Transaction application 110 stores the fully populated transaction data 114—including the determined amount 226, recipient identifier 246, and product identifier 250 (if applicable)—into a local database or memory structure. Processed flag 228 is set to "false" or "pending." This step effectively queues the financial event for future confirmation and settlement, completing the generation process for a single interaction instance. In one or more embodiments, if the system determines that user 350 possesses a pre-funded account (e.g., a positive balance in a front-loaded wallet) and the content 244 is live, the transaction application 110 may automatically set the processed flag 228 to 'true' or 'complete.' In this scenario, the transaction bypasses the pending transaction dashboard 670 and is immediately submitted for settlement, allowing the gesture to function as an instantaneous tip.

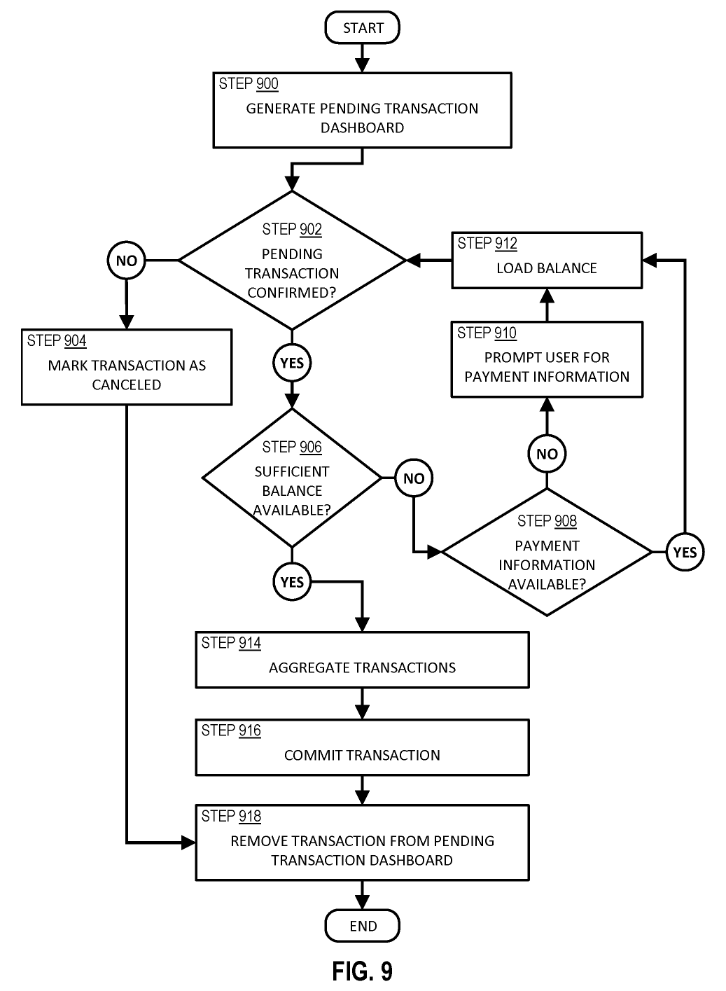

### FIG. 9

FIG. 9 is a flowchart of a method for confirming or canceling transactions. All or a portion of the method in this flowchart shown may be performed by one or more components of information handling system 1201 or a user thereof. While the various steps in this flowchart are presented and described sequentially, a person of ordinary skill in the relevant art (having the benefit of this detailed description) would appreciate that some or all steps may be executed in different orders, combined, or omitted, and some or all steps may be executed in parallel.

In Step 900, pending transaction dashboard 670 is generated and displayed. Transaction application 110 renders the list of uncommitted transaction data 114 on digital display 352, allowing user 350 to review, manage, and select accumulated pledges, tips, or product purchases for finalization.

In Step 902, a determination is made as to whether a pending transaction is confirmed by user 350. Transaction application 110 monitors for specific input events within transaction dashboard 670, such as a "commit" button press or a directional swipe on a specific row.

If a determination is made that the pending transaction is not confirmed (e.g., explicitly cancelled) (Step 902-NO), then the method proceeds to Step 904. Otherwise, if a determination is made that the pending transaction is confirmed (Step 902-YES), then the method proceeds to Step 906.

In Step 904, the transaction is marked as canceled. Transaction application 110 updates the status of the specific transaction data 114 (e.g., setting processed flag 228 to a null or void state) and removes it from the active view of transaction dashboard 670. Accordingly, unwanted pledges are not submitted for financial settlement.

In Step 906, a determination is made as to whether sufficient balance is available in a pre-loaded account or wallet. Transaction application 110 checks user data 116 for existing credits or a stored value balance sufficient to cover amount 226 of the confirmed transaction. This check allows for instantaneous settlement without repeated external authorization requests.

If a determination is made that sufficient balance is not available (Step 906-NO), then the method proceeds to Step 908. Otherwise, if a determination is made that sufficient balance is available (Step 906-YES), then the method proceeds to Step 914.

In Step 908, a determination is made as to whether valid payment information 234 is already available and associated with user 350. Transaction application 110 queries user data 116 to verify the presence of a tokenized credit card or bank credential.

If a determination is made that payment information is not available (Step 908-NO), then the method proceeds to Step 910. Otherwise, if a determination is made that payment information is available (Step 908-YES), then the method proceeds to Step 912.

In Step 910, user 350 is prompted to provide payment information. Transaction application 110 displays a secure input form on digital display 352 requesting credit card details or other financial credentials, which are subsequently verified and tokenized.

In Step 912, the necessary balance is loaded or authorized. Transaction application 110 utilizes the available or newly provided payment information 234 to secure the funds required for the transaction, potentially topping up a digital wallet or authorizing a specific charge to cover the deficit identified in Step 906. The method may then return to Step 902.

In Step 914, transactions are aggregated. Transaction application 110 or transaction server 106 may group multiple confirmed instances of transaction data 114 into a single financial payload to minimize processing fees, while retaining the granular breakdown (e.g., separate beneficiary amounts) for backend accounting.

In Step 916, the transaction is committed. The aggregated financial data is transmitted to transaction server 106 and/or an external payment processor for final settlement. Processed flag 228 associated with the transaction is updated to a "true" or "complete" state.

In Step 918, the transaction is removed from pending transaction dashboard 670. Upon successful commitment, the visual representation of the transaction is cleared from the queue, indicating to user 350 that the process is complete, and funds have been allocated.

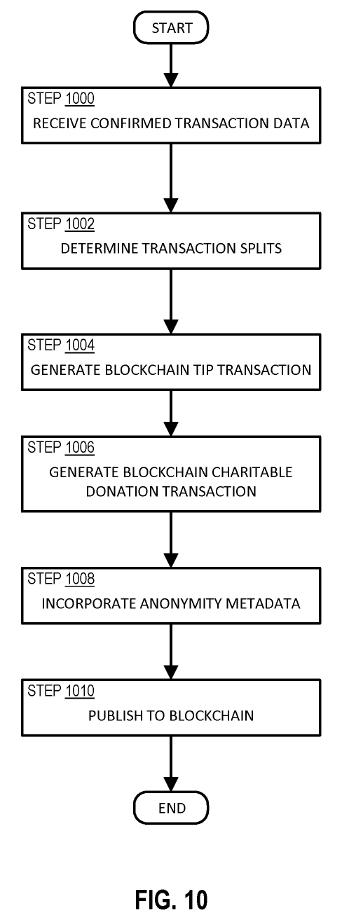

### FIG. 10

FIG. 10 is a flowchart of a method for publishing transaction data. All or a portion of the method in this flowchart shown may be performed by one or more components of information handling system 1201 or a user thereof. While the various steps in this flowchart are presented and described sequentially, a person of ordinary skill in the relevant art (having the benefit of this detailed description) would appreciate that some or all steps may be executed in different orders, combined, or omitted, and some or all steps may be executed in parallel.

In Step 1000, confirmed transaction data 114 is received by transaction server 106. Following the financial commitment of funds (as described in the method of FIG. 9), the aggregated payload of verified transactions is ingested by the backend system for post-processing and transparency recording. This data includes the fully settled amounts, recipient identifiers, and user credentials necessary to create a permanent public record.

In Step 1002, transaction splits are determined. Transaction server 106 parses the aggregated financial total to identify specific allocations associated with each distinct interaction. As a non-limiting example, a single financial charge of $2.00 may be divided internally into a tip portion for the content creator and a charitable donation portion for a designated organization. This step facilitates that distributed ledger 104 reflects the specific beneficiaries and distinct flow of funds rather than just the total lump sum charged to the credit card of user 350.

In Step 1004, a blockchain tip transaction is generated. Transaction server 106 constructs a specific digital record or token transfer representing the portion of funds allocated directly to the content creator. This record may utilize a utility token format (e.g., a "give coin") to provide a transparent, public accounting of the value transferred without exposing sensitive banking details or fiat currency routing numbers.

In Step 1006, a blockchain charitable donation transaction is generated. Transaction server 106 constructs a distinct digital record representing the portion of funds allocated to a charitable organization (e.g., recipient identifier 246). This separation allows charitable giving to be tracked independently of personal tips, facilitating accurate auditing, public transparency regarding charitable impact, and the potential issuance of tax receipts.

In Step 1008, anonymity metadata is incorporated into the transaction records. Transaction server 106 checks anonymity flag 232 and privacy preferences 243 associated with user 350. If anonymity is requested, user identifier 222 is replaced with a hashed, randomized, or otherwise obscured string (e.g., "Anonymous User") within the public-facing blockchain data. Thus, while the value flow and timestamp remain transparent, the specific identity of the donor may remain private on the public ledger.

In Step 1010, the generated transactions are published to distributed ledger 104. Transaction server 106 (or a dedicated blockchain writer module) transmits the finalized, split, and anonymized records to the decentralized network for immutable storage. Once confirmed on the ledger, these records become available for public auditing and leaderboard generation.

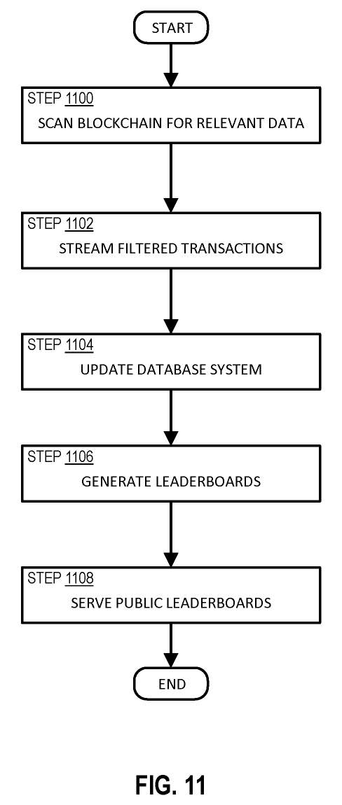

### FIG. 11

FIG. 11 is a flowchart of a method for scanning public transaction data and updating transactions data. All or a portion of the method in this flowchart shown may be performed by one or more components of information handling system 1201 or a user thereof. While the various steps in this flowchart are presented and described sequentially, a person of ordinary skill in the relevant art (having the benefit of this detailed description) would appreciate that some or all steps may be executed in different orders, combined, or omitted, and some or all steps may be executed in parallel.

In Step 1100, distributed ledger 104 is scanned for relevant transaction data. Ledger scanner 107 may continuously monitor the blocks or transaction streams of the decentralized network for entries containing specific metadata, cryptographic signatures, or protocols associated with the disclosed system. This scanning process may ensure that all publicly committed financial events, including tips and donations recorded via utility tokens, are detected in real-time or near real-time, regardless of where the transaction originated.

In Step 1102, filtered transactions are streamed for processing. Ledger scanner 107 distinguishes between relevant system transactions and unrelated blockchain activity. If the transaction metadata matches the criteria of the system, the data is extracted and enqueued for internal processing. This filtering mechanism may ensure that transaction server 106 only expends resources processing data related to the specific ecosystem of pledges and product purchases.

In Step 1104, the database system is updated with the scanned data. Transaction server 106 ingests the filtered blockchain records and updates the internal transaction data 114 or a dedicated leaderboard table. This step serves as a reconciliation mechanism, verifying that the immutable public record matches the internal logs of pledges and payments. By syncing the database with distributed ledger 104, the system attempts to ensure that the data utilized for analytics and display is verified against the tamper-proof public chain.

In Step 1106, leaderboards are generated based on the updated transaction data. Transaction server 106 calculates rankings and aggregates totals to populate various competitive lists, such as "Top Content Creator," "Top Charitable Recipient," or "Top Giver". This process typically involves querying the reconciled database to determine which users or entities have accumulated the highest value of contributions over a specific period, utilizing the transparency of the blockchain to validate the scores.

In Step 1108, public leaderboards are served to user device 100. The generated rankings are transmitted via network 101 to content application 108 or a dedicated web interface. User 350 may view these leaderboards to see real-time updates of charitable impact or community engagement. This public display provides "social proof" and gamification incentives (e.g., "bragging rights") to encourage further participation in the ecosystem.

### FIG. 12

FIG. 12 is a diagram of an example computing environment. Computing environment 1200 may include one or more information handling systems 1201 connected via network 101. Further, resource manager 1218 may aggregate and manage the allocation of the computing resources (of one or more information handling systems 1201) into computing resource pools 1220. Those computing resource pools 1220 may then be allocated to various virtualized and/or logical components (e.g., virtual machines 1230, virtual storage volumes 1238, etc.). Each of these components is described below.

Information handling system 1201 is a hardware computing device which may be utilized to perform various steps, methods, and techniques disclosed herein (e.g., via the execution of software). In any embodiment, information handling system 1201 may include one or more processors 1202, cache 1204, memory 1206, storage 1208, and/or one or more peripheral devices 1209. Any two or more of these components may be operatively connected via a system bus (not shown) which provides a means for transferring data between those components. Although each component is depicted and disclosed as individual functional components, these individual components may be combined (or divided) into any combination or configuration of components.

A system bus is a system of hardware connections (e.g., sockets, ports, wiring, conductive tracings on a printed circuit board (PCB), etc.) used for sending (and receiving) data to (and from) each of the components connected thereto. In any embodiment, a system bus allows for communication via an interface and protocol (e.g., inter-integrated circuit (I2C), peripheral component interconnect (express) (PCI(e)) fabric, etc.) which may be commonly recognized by the components utilizing the system bus. In any embodiment, a basic input/output system (BIOS) may be configured to transfer information between the components using the system bus (e.g., during initialization of information handling system 1201).

In any embodiment, information handling system 1201 may additionally include internal physical interfaces (e.g., serial advanced technology attachment (SATA) ports, peripheral component interconnect (PCI) ports, PCI express (PCIe) ports, next generation form factor (NGFF) ports, M.2 ports, etc.) and/or external physical interfaces (e.g., universal serial bus (USB) ports, recommended standard (RS) serial ports, audio/visual ports, etc.). Internal physical interfaces and external physical interfaces may facilitate the operative connection to one or more peripheral devices 1209.

Non-limiting examples of information handling system 1201 include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of computing device with the aforementioned capabilities. Further, information handling system 1201 may be operatively connected to another information handling system 1201 via network 101 in a distributed computing environment. As used herein, a "computing device" may be equivalent to an information handling system.

Processor 1202 is a hardware device which may take the form of an integrated circuit configured to process computer-executable instructions (e.g., software). Processor 1202 may execute (e.g., read and process) computer-executable instructions stored in cache 1204, memory 1206, and/or storage 1208. Processor 1202 may be a self-contained computing system, including a system bus, memory, cache, and/or any other components of a computing device. Processor 1202 may include multiple processors, such as a system having multiple, physically separate processors in different sockets, or a system having multiple processor cores on a single physical chip. A multi-core processor may be symmetric or asymmetric. Multiple processors 1202, and/or processor cores thereof, may share resources (e.g., cache 1204, memory 1206) or may operate using independent resources.

Non-limiting examples of processor 1202 include general-purpose processor (e.g., a central processing unit (CPU)), an application specific integrated circuit (ASIC), a programmable gate array (PGA), a field programmable gate array (FPGA), a digital signal processor (DSP), and any digital or analog circuit configured to perform operations based on input data (e.g., execute program instructions).

Cache 1204 is one or more hardware devices capable of storing digital information (e.g., data) in a non-transitory medium. Cache 1204 expressly excludes transitory media (e.g., transitory waves, energy, carrier signals, electromagnetic waves, signals per se, etc.). Cache 1204 may be considered "high-speed", having comparatively faster read/write access than memory 1206 and storage 1208, and therefore utilized by processor 1202 to process data more quickly than data stored in memory 1206 or storage 1208. Accordingly, processor 1202 may copy needed data to cache 1204 (from memory 1206 and/or storage 1208) for comparatively speedier access when processing that data. In any embodiment, cache 1204 may be included in processor 1202 (e.g., as a subcomponent). In any embodiment, cache 1204 may be physically independent, but operatively connected to processor 1202.

Memory 1206 is one or more hardware devices capable of storing digital information (e.g., data) in a non-transitory medium. Memory 1206 expressly excludes transitory media (e.g., transitory waves, energy, carrier signals, electromagnetic waves, signals per se, etc.). In any embodiment, when accessing memory 1206, software (executed via processor 1202) may be capable of reading and writing data at the smallest units of data normally accessible (e.g., "bytes"). Specifically, memory 1206 may include a unique physical address for each byte stored thereon, thereby enabling the ability to access and manipulate (read and write) data by directing commands to a specific physical address associated with a byte of data (i.e., "random access"). Non-limiting examples of memory 1206 devices include flash memory, random access memory (RAM), dynamic RAM (DRAM), static RAM (SRAM), resistive RAM (ReRAM), read-only memory (ROM), and electrically erasable programmable ROM (EEPROM). In any embodiment, memory 1206 devices may be volatile or non-volatile.

Storage 1208 is one or more hardware devices capable of storing digital information (e.g., data) in a non-transitory medium. Storage 1208 expressly excludes transitory media (e.g., transitory waves, energy, carrier signals, electromagnetic waves, signals per se, etc.). In any embodiment, the smallest unit of data readable from storage 1208 may be a "block" (instead of a "byte"). Prior to reading and/or manipulating the data on storage 1208, one or more blocks may be copied to an intermediary storage medium (e.g., cache 1204, memory 1206) where the data may then be accessed in "bytes" (e.g., via random access). In any embodiment, data on storage 1208 may be accessed in "bytes" (like memory 1206). Non-limiting examples of storage 1208 include integrated circuit storage devices (e.g., a solid-state drive (SSD), Non-Volatile Memory Express (NVMe), flash memory, etc.), magnetic storage devices (e.g., a hard disk drive (HDD), floppy disk, magnetic tape, diskette, cassettes, etc.), optical media (e.g., a compact disc (CD), digital versatile disc (DVD), etc.), and printed media (e.g., barcode, quick response (QR) code, punch card, etc.).

As used herein, "non-transitory computer readable medium" is cache 1204, memory 1206, storage 1208, and/or any other hardware device capable of non-transitorily storing and/or carrying data.

Peripheral device 1209 is a hardware device configured to send (and/or receive) data to (and/or from) information handling system 1201 via one or more internal and/or external physical interfaces. Any peripheral device 1209 may be categorized as one or more "types" of computing devices (e.g., an "input" device, "output" device, "communication" device, etc.). However, such categories are not comprehensive and are not mutually exclusive. Such categories are listed herein strictly to provide understandable groupings of the potential types of peripheral devices 1209. As such, peripheral device 1209 may be an input device, an output device, a communication device, and/or any other optional computing component.

An input device is a hardware device which receives data into information handling system 1201. In any embodiment, an input device may be a human interface device which facilitates user interaction by collecting data based on user inputs (e.g., a mouse, keyboard, camera, microphone, touchpad, touchscreen, fingerprint reader, joystick, gamepad, etc.). In any embodiment, an input device may collect data based on raw inputs, regardless of human interaction (e.g., any sensor, logging tool, audio/video capture card, etc.). In any embodiment, an input device may be a reader for accessing data on a non-transitory computer readable medium (e.g., a CD drive, floppy disk drive, tape drive, scanner, etc.).

An output device is a hardware device which sends data from information handling system 1201. In any embodiment, an output device may be a human interface device which facilitates providing data to a user (e.g., a visual display monitor, speakers, printer, status light, haptic feedback device, etc.). In any embodiment, an output device may be a writer for facilitating storage of data on a non-transitory computer readable medium (e.g., a CD drive, floppy disk drive, magnetic tape drive, printer, etc.).

A communication device is a hardware device capable of sending and/or receiving data with one or more other communication devices (e.g., connected to another information handling system 1201 via network 101). A communication device may communicate via any suitable form of wired interface (e.g., Ethernet, fiber optic, serial communication etc.) and/or wireless interface (e.g., Wi-Fi® (Institute of Electrical and Electronics Engineers (IEEE) 802.11), Bluetooth® (IEEE 802.15.1), etc.) and utilize one or more protocols for the transmission and receipt of data (e.g., transmission control protocol (TCP), user datagram protocol (UDP), internet protocol (IP), remote direct memory access (RDMA), etc.). Non-limiting examples of a communication device include a network interface card (NIC), a modem, an Ethernet card/adapter, and a Wi-Fi® card/adapter.

An optional computing component is any hardware device which operatively connects to information handling system 1201 and extends the capabilities of information handling system 1201. Non-limiting examples of an optional computing component include a graphics processing unit (GPU), a data processing unit (DPU), and a docking station.

As used herein, "software" (e.g., "code", "algorithm", "application", "routine") is data in the form of computer-executable instructions. Processor 1202 may execute (e.g., read and process) software to perform one or more functions. Non-limiting examples of functions may include reading existing data, modifying existing data, generating new data, and using any capability of information handling system 1201 (e.g., reading existing data from memory 1206, generating new data from the existing data, sending the generated data to a GPU to be displayed on a monitor). Although software physically persists in cache 1204, memory 1206, and/or storage 1208, one or more software instances may be depicted, in the figures, as an external component of any information handling system 1201 which interacts with one or more information handling systems 1201.

As used herein, "computing resource" refers to the functional capabilities (and/or portions of functional capabilities) of any component of information handling system 1201. As an example, processor 1202 may have "processor resources" which may be divided into slices of processor time, any of which may be considered a "computing resource". Cache 1204, memory 1206, and storage 1208 may each be categorized into their own type of "computing resource", as well as any smaller increment of storage therein (e.g., "bytes", "blocks"). As a non-limiting example, a single memory 1206 device may be divided into ranges of bytes which may be separately allocated. The storage capacity of the entire memory 1206 device may be considered a "computing resource" while any subdivision (byte range) thereof may also be considered a "computing resource". As another non-limiting example, a network interface card may have a total throughput capacity which may be divided into portions of bandwidth. The entire throughput capacity may be considered a "computing resource" while a smaller portion (bandwidth) may also be considered a "computing resource".

Resource manager 1218 is a software instance which manages the allocation of computing resources. In any embodiment, resource manager 1218 is configured (i.e., programmed) to query one or more information handling systems 1201 to identify the computing resources available therein, and in turn, may aggregate those computing resources into one or more computing resource pools 1220, per the type of computing resource. Resource manager 1218 may use one or more databases (e.g., database 1240) to track the availability, allocation, and/or utilization of computing resources (e.g., as computing resource pools 1220). In any embodiment, resource manager 1218 may create, initialize, stop, and/or terminate one or more virtual machines 1230, software containers, virtual storage volumes 1238, and/or databases 1240. Non-limiting examples of resource manager 1218 include any orchestrator, hypervisor, and/or container manager.

Computing resource pool 1220 is a data structure which includes one or more pools for specific types of computing resources (e.g., processing pools 1222, memory pools 1226, storage pools 1228, peripheral device pools 1229, etc.). In any embodiment, computing resource pool 1220 is a data structure, created and/or managed by resource manager 1218, which tracks the various computing resources of information handling systems 1201 in computing environment 1200. Computing resource pools 1220 may take the form of a table, file, and/or any other data structure capable of including information relevant to computing resources.

Processing pool 1222 is a data structure which includes an aggregation of the capabilities and/or functionalities of one or more processors 1202 in one or more information handling systems 1201. In any embodiment, processing pool 1222 presents a unified virtual computing resource which may be allocated, by resource manager 1218, to any software (e.g., virtual machine 1230) and/or virtual storage volume 1238.

Memory pool 1226 is a data structure which includes an aggregation of the capabilities and/or functionalities of one or more memory 1206 devices in one or more information handling systems 1201. In any embodiment, memory pool 1226, presents a unified virtual computing resource which may be allocated, by resource manager 1218, to any software (e.g., virtual machine 1230) and/or virtual storage volume 1238.

Storage pool 1228 is a data structure which includes an aggregation of the capabilities and/or functionalities of one or more storage 1208 devices in one or more information handling systems 1201. In any embodiment, storage pool 1228 presents a unified virtual computing resource which may be allocated, by resource manager 1218, to any software (e.g., virtual machine 1230) and/or virtual storage volume 1238.

Peripheral device pool 1229 is a data structure which includes an aggregation of the capabilities and/or functionalities of one or more peripheral devices 1209 in one or more information handling systems 1201. In any embodiment, peripheral device pool 1229 presents a unified virtual computing resource which may be allocated, by resource manager 1218, to any software (e.g., virtual machine 1230) and/or virtual storage volume 1238.

Virtual machine 1230 is a software instance which provides a virtual environment in which other software may execute. In any embodiment, virtual machine 1230 may be created by resource manager 1218, where resource manager 1218 allocates some portion of computing resources (e.g., in one or more computing resource pools 1220) to virtual machine 1230 to initialize and execute. In any embodiment, within virtual machine 1230, the computing resources may be aggregated from one or more information handling systems 1201 (e.g., via computing resource pools 1220) and presented as unified "virtual" resources within virtual machine 1230 (e.g., virtual processors, virtual memory, virtual storage, virtual peripheral devices, etc.). As computing resource pools 1220 are used to generate virtual machine 1230, the underlying hardware storing, executing, and processing the operations (of virtual machine 1230) may be disposed in any number of information handling systems 1201.

Virtual storage volume 1238 is a virtual space for storing data. In any embodiment, virtual storage volume 1238 may use any suitable means of underlying devices for storing data (e.g., cache 1204, memory 1206, storage 1208) via one or more computing resource pools 1220. In any embodiment, virtual storage volume 1238 may be managed by virtual machine 1230, where virtual machine 1230 handles the access (reads/writes), filesystem, redundancy, and addressability of the data stored therein.

Database 1240 is a data structure which stores information in relational tuples and attributes. In any embodiment, database 1240 may be stored on virtual storage volume 1238 and/or directly on a single information handling system 1201. Non-limiting examples of database 1240 include one or more tables each with one or more "rows" (e.g., tuples) and "columns" (e.g., attributes), a structured file for storing tabular data (e.g., a comma-separated value (CSV) file, a tab-separated value (TSV) file, etc.), a relational database management system (RDBMS) (e.g., using structured query language (SQL)), and/or any other data structure capable of storing data.

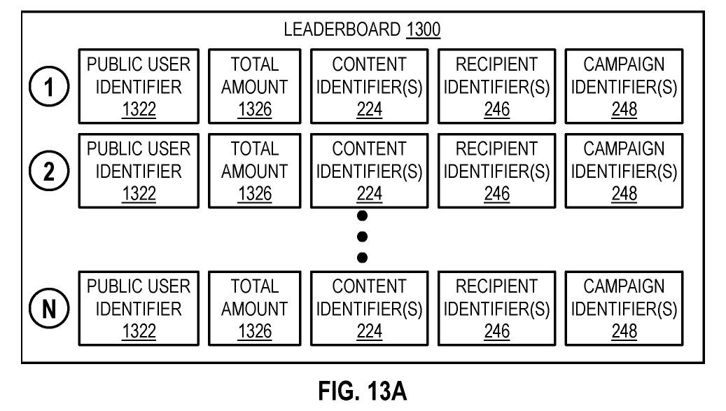

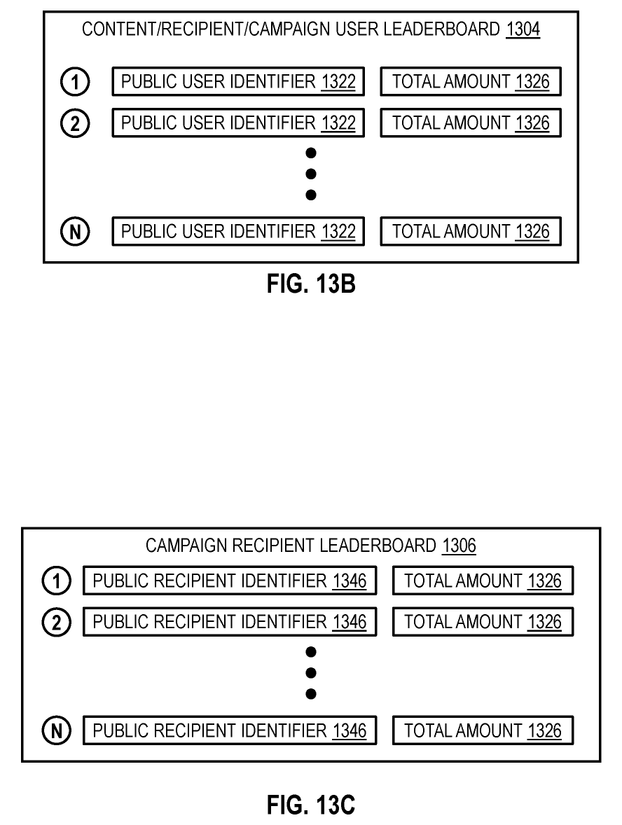

### FIGS. 13A-13C

FIG. 13A is a diagram of an example leaderboard. FIG. 13B is a diagram of an example content/recipient/campaign user leaderboard. FIG. 13C is a diagram of an example campaign recipient leaderboard.

Leaderboard 1300 is a digital interface element, data structure, or ranking list configured to present a hierarchical arrangement of users based on cumulative financial contributions. Leaderboard 1300 may be generated by ledger scanner 107 or transaction server 106 utilizing data retrieved from distributed ledger 104. Leaderboard 1300 may function as a general list of top users who have paid the most, as indicated by total amount 1326 associated with each entry. Leaderboard 1300 may organize data such that public user identifier 1322 is visually associated with total amount 1326, allowing for the public recognition of top contributors. Additionally, leaderboard 1300 may incorporate specific metadata to contextualize the contributions, including one or more content identifier(s) 224, recipient identifier(s) 246, and/or campaign identifier(s) 248. These identifiers may be presented in the same row or logical grouping as public user identifier 1322, thereby linking a user's generosity to specific media, beneficiaries, or fundraising drives. Leaderboard 1300 may be rendered on digital display 352.

Content/recipient/campaign user leaderboard 1304 is a specialized graphical user interface element, data structure, or ranking list configured to present transaction data filtered by a specific contextual criterion. Content/recipient/campaign user leaderboard 1304 may operate similarly to leaderboard 1300 but may restrict the displayed information to transactions associated with a particular subject, such as a specific media item, beneficiary, or fundraising initiative. Content/recipient/campaign user leaderboard 1304 may provide a streamlined view connecting public user identifier 1322 with a corresponding total amount 1326 accumulated specifically for the selected filter. Content/recipient/campaign user leaderboard 1304 may allow user 350 to visualize top contributors for a unique content identifier 224, recipient identifier 246, or campaign identifier 248, rather than viewing a global aggregation of all system transactions. Content/recipient/campaign user leaderboard 1304 may be generated dynamically by ledger scanner 107 upon a request to view statistics for a specific entity represented by public content/recipient/campaign identifier. Content/recipient/campaign user leaderboard 1304 may facilitate targeted social recognition, allowing users to see who has donated the most to a specific charity or who has tipped the most on a specific video. Content/recipient/campaign user leaderboard 1304 may be rendered on digital display 352.

Campaign recipient leaderboard 1306 is a digital interface element, data structure, or ranking list configured to present a hierarchical arrangement of recipients based on an aggregate value of contributions received during a specific fundraising event. Campaign recipient leaderboard 1306 may be generated by transaction server 106 or ledger scanner 107 through the aggregation of transaction data 114 sharing a common campaign identifier 248. Similar to content/recipient/campaign user leaderboard 1304, campaign recipient leaderboard 1306 may provide a sorted visualization of performance, yet campaign recipient leaderboard 1306 may be distinct in that campaign recipient leaderboard 1306 highlights the entities raising funds rather than the users providing funds. Specifically, campaign recipient leaderboard 1306 may display a listing of public recipient identifiers 1346 alongside corresponding total amounts 1326. This configuration may allow user 350 to identify which content creators or beneficiaries are most effective at driving donations for a given cause. Campaign recipient leaderboard 1306 may be rendered on digital display 352 and updated dynamically as new transactions are committed to distributed ledger 104. Additionally, campaign recipient leaderboard 1306 may foster competition among content creators by publicly showcasing the success of their respective fundraising efforts.

Public user identifier 1322 is an identifier which may be a data sequence, alphanumeric string, or label configured to represent a specific entity within a publicly viewable interface. Public user identifier 1322 may be similar to user identifier 222, distinct in that public user identifier 1322 is specifically formatted for external presentation rather than internal database indexing. Public user identifier 1322 may comprise a unique username, a handle, or a display name chosen by user 350 to represent an account on a social platform or within leaderboard 1300. Additionally, public user identifier 1322 may be utilized to associate a specific rank or contribution on content/recipient/campaign user leaderboard 1304 with total amount 1326 contributed by user 350. Public user identifier 1322 may be subject to modification based on privacy preferences 243 and the status of anonymity flag 232 stored within user data 116. For instance, if anonymity flag 232 indicates a preference for privacy, public user identifier 1322 may be generated as a generic or obfuscated alias (e.g., "Anonymous Donor") to mask the true identity of user 350 on distributed ledger 104 or public displays. In certain configurations, public user identifier 1322 may be completely excluded from generated lists to ensure user 350 anonymity is preserved.

Total amount 1326 is a numerical data value, aggregated sum, or financial metric representing the cumulative magnitude of contributions made by a specific user 350. Total amount 1326 may be computed by transaction server 106 or ledger scanner 107 through the summation of multiple discrete instances of transaction data 114 recorded on distributed ledger 104. When displayed within leaderboard 1300, total amount 1326 may reflect the gross quantity of all value transferred by user 350 across all interactions, regardless of the beneficiary or content context. Conversely, when utilized within content/recipient/campaign user leaderboard 1304, total amount 1326 may represent a filtered sum restricted to specific contexts defined by recipient identifier 246, content identifier 224, or campaign identifier 248. Total amount 1326 may be denominated in fiat currency or utility tokens. Total amount 1326 may be dynamically updated in real-time as new transactions are verified, thereby determining the relative ranking of public user identifier 1322 within the listing.

Public recipient identifier 1346 is an identifier which may be a data sequence, alphanumeric string, or graphical label configured to represent a specific beneficiary, content creator, or organization within a publicly viewable interface. Public recipient identifier 1346 may be rendered on digital display 352 as a component of campaign recipient leaderboard 1306. Public recipient identifier 1346 may be derived from recipient identifier 246 associated with content data 112 or transaction data 114. Public recipient identifier 1346 may be distinct from internal database keys in that public recipient identifier 1346 is formatted for public recognition, such as a social media handle, a channel name, or a charitable organization name. Public recipient identifier 1346 may be visually associated with total amount 1326 to indicate the aggregate value of funds raised by the identified entity during a specific campaign or time period. Public recipient identifier 1346 may be utilized to foster competition by publicly identifying leading fundraisers. Public recipient identifier 1346 may be retrieved by ledger scanner 107 during the generation of the ranking list.

### Statements

The systems and methods may comprise any of the various features disclosed herein, including one or more of the following statements.

Statement 1. A method for managing transactions, the method comprising detecting a user interaction on visual content displayed on a digital display; identifying whether the user interaction occurred within a visual interactive area associated with a visual component of the visual content; or an audio interactive area associated with an auditory component of the visual content; selecting a beneficiary based on whether the user interaction occurred within the visual interactive area or the audio interactive area; generating a transaction in response to the user interaction, wherein the transaction is associated with a monetary value and the beneficiary; and displaying a visual confirmation on the digital display overlaid on the visual content.

Statement 2. The method of statement 1, further comprising adding the transaction to a transaction queue, wherein the transaction queue is configured to hold a plurality of pending transactions prior to financial commitment; receiving a confirmation input to commit the transaction queue; and initiating a financial transfer for an aggregated value of the plurality of pending transactions held in the transaction queue.

Statement 3. The method of statement 2, further comprising determining splits for the plurality of pending transactions, wherein the splits allocate a first portion of the monetary value to a content creator and a second portion of the monetary value to a charitable organization; and generating distinct tracking records for the first portion and the second portion.

Statement 4. The method of statement 3, further comprising publishing the distinct tracking records to a blockchain ledger utilizing a utility token; scanning the blockchain ledger to retrieve the distinct tracking records; and generating a public leaderboard based on the distinct tracking records retrieved from the blockchain ledger.

Statement 5. The method of statement 4, further comprising anonymizing a user identifier associated with the distinct tracking records prior to publishing to the blockchain ledger based on a privacy setting associated with a user.

Statement 6. The method of any of statements 1-5 further comprising retrieving a product identifier associated with a coordinate location of the user interaction; and setting the monetary value based on a fixed price associated with the product identifier.

Statement 7. The method of any of statements 1-6 further comprising assigning a temporary guest identifier prior to generating the transaction; and merging the transaction with a registered user account upon a subsequent authentication.

Statement 8. An information handling system comprising a processor; and a memory communicatively coupled to the processor, the memory storing instructions which, when executed by the processor, cause the processor to detect a user interaction within a visual interactive area defined on a digital display while content data is being presented; generate, in response to the user interaction, transaction data comprising a transaction identifier and an amount; assign a pending status to the transaction data; and generate a visual confirmation of the user interaction for display on the digital display, wherein the visual confirmation is superimposed over the content data without interrupting a playback of the content data.

Statement 9. The information handling system of statement 8, wherein the instructions further cause the processor to store the transaction data in a pending transaction dashboard, wherein the pending transaction dashboard accumulates a plurality of transaction data without executing a financial settlement; receive a commit command associated with the pending transaction dashboard; execute the financial settlement for the transaction data stored in the pending transaction dashboard in response to the commit command; calculate a total settlement amount by aggregating the amount associated with each of the plurality of transaction data stored in the pending transaction dashboard; and transmit the total settlement amount to a payment processor as a single financial charge.

Statement 10. The information handling system of statement 9, wherein the instructions further cause the processor to identify a recipient identifier associated with the transaction data, wherein the recipient identifier designates a content creator or a charitable organization; generate a blockchain transaction record corresponding to the transaction data, wherein the blockchain transaction record comprises the amount and the recipient identifier; and publish the blockchain transaction record to a distributed ledger using a utility token, wherein the utility token represents the amount for transparency purposes distinct from the financial settlement.

Statement 11. The information handling system of statement 10, wherein the instructions further cause the processor to scan the distributed ledger to detect the blockchain transaction record; and update a leaderboard database based on the blockchain transaction record scanned from the distributed ledger.

Statement 12. The information handling system of any of statements 8-11 wherein the instructions further cause the processor to detect a subsequent user interaction within the visual interactive area; determine if the subsequent user interaction occurs within a time threshold of the user interaction; and increase the amount associated with the subsequent user interaction relative to the transaction data if the subsequent user interaction occurs within the time threshold.

Statement 13. The information handling system of any of statements 8-12 wherein the user interaction comprises a multi-touch gesture, and the instructions further cause the processor to determine a quantity of contacts associated with the multi-touch gesture; and set the amount for the transaction data based on the quantity of contacts.

Statement 14. The information handling system of any of statements 8-13 wherein the content data comprises a video stream, and wherein the instructions further cause the processor to track a movement of a specific object within the video stream; and dynamically adjust boundaries of the visual interactive area to correspond to the movement of the specific object.

Statement 15. An information handling system comprising a network interface; and a processor communicatively coupled to the network interface, wherein the processor is configured to receive confirmed transaction data comprising a plurality of individual transactions initiated by a user during a content consumption session; calculate an aggregate total of the plurality of individual transactions; transmit the aggregate total to a payment processor for a single financial settlement; generate a plurality of blockchain transaction records corresponding to the plurality of individual transactions, wherein each of the plurality of blockchain transaction records utilizes a utility token to represent a value of a corresponding individual transaction; and publish the plurality of blockchain transaction records to a distributed ledger.

Statement 16. The information handling system of statement 15, wherein the processor is further configured to scan the distributed ledger to identify the plurality of blockchain transaction records; filter the plurality of blockchain transaction records based on a relevance protocol; and update a leaderboard system using data extracted from the plurality of blockchain transaction records.

Statement 17. The information handling system of any of statements 15-16 wherein the processor is further configured to parse a specific transaction of the plurality of individual transactions into a tip portion and a donation portion; generate a first blockchain transaction record for the tip portion directed to a content creator; and generate a second blockchain transaction record for the donation portion directed to a charitable organization.

Statement 18. The information handling system of any of statements 15-17 wherein the utility token is a tracking unit denominated in a fiat currency but possessing no inherent tradeable value.

Statement 19. The information handling system of any of statements 15-18 wherein the processor is further configured to check a privacy preference associated with the user; and replace a user identifier in the plurality of blockchain transaction records with an anonymized string if the privacy preference indicates anonymity.

Statement 20. The information handling system of any of statements 15-19 wherein the processor is further configured to receive a signal indicating a user interaction with a dynamic product interactive area tracking an object moving within a video; and assign a fixed product price to a specific transaction of the plurality of individual transactions based on the signal.

### General Notes

As it is impracticable to disclose every conceivable embodiment of the technology described herein, the figures, examples, and description provided herein disclose only a limited number of potential embodiments. A person of ordinary skill in the relevant art would appreciate that any number of potential variations or modifications may be made to the explicitly disclosed embodiments, and that such alternative embodiments remain within the scope of the broader technology. Accordingly, the scope should be limited only by the attached claims. Further, the compositions and methods are described in terms of "comprising," "containing," or "including" various components or steps; the compositions and methods may also "consist essentially of" or "consist of" the various components and steps. Certain technical details, known to those of ordinary skill in the relevant art, may be omitted for brevity and to avoid cluttering the description of the novel aspects.

For further brevity, descriptions of similarly named components may be omitted if a description of that similarly named component exists elsewhere in the application. Accordingly, any component described with respect to a specific figure may be equivalent to one or more similarly named components shown or described in any other figure, and each component incorporates the description of every similarly named component provided in the application (unless explicitly noted otherwise). A description of any component is to be interpreted as an optional embodiment—which may be implemented in addition to, in conjunction with, or in place of an embodiment of a similarly-named component described for any other figure.

### Lexicographical Notes

As used herein, adjective ordinal numbers (e.g., first, second, third, etc.) are used to distinguish between elements and do not create any ordering of the elements. As an example, a "first element" is distinct from a "second element", but the "first element" may come after (or before) the "second element" in an ordering of elements. Accordingly, an order of elements exists only if ordered terminology is expressly provided (e.g., "before", "between", "after", etc.) or a type of "order" is expressly provided (e.g., "chronological", "alphabetical", "by size", etc.). Further, use of ordinal numbers does not preclude the existence of other elements. As an example, a "table with a first leg and a second leg" is any table with two or more legs (e.g., two legs, five legs, thirteen legs, etc.). A maximum quantity of elements exists only if express language is used to limit the upper bound (e.g., "two or fewer", "exactly five", "nine to twenty", etc.). Similarly, singular use of an ordinal number does not imply the existence of another element. As an example, a "first threshold" may be the only threshold and therefore does not necessitate the existence of a "second threshold".

As used herein, the word "data" may be used as an "uncountable" singular noun—not as the plural form of the singular noun "datum". Accordingly, throughout the application, "data" is generally paired with a singular verb (e.g., "the data is modified"). However, "data" is not redefined to mean a single bit of digital information. Rather, as used herein, "data" means any one or more bits of digital information which are grouped together (physically or logically). Further, "data" may be used as a plural noun if context provides the existence of multiple "data" (e.g., "the two data are combined").

As used herein, the term "operative connection" (or "operatively connected") means the direct or indirect connection between devices which allows for the transmission of data. For example, the phrase 'operatively connected' may refer to a direct connection (e.g., a direct wired or wireless connection between devices) or an indirect connection (e.g., multiple wired and/or wireless connections between any number of other devices connecting the operatively connected devices).

As used herein, indefinite articles "a" and "an" mean "one or more". That is, the explicit recitation of "an" element does not preclude the existence of a second element, a third element, etc. Further, definite articles (e.g., "the", "said") mean "any one of" (the "one or more" elements) when referring to previously introduced elements. As an example, there may be "a processor", where such a recitation does not preclude the existence of any number of other processors. Further, "the processor receives data, and the processor processes data" means "any one of the one or more processors receives data" and "any one of the one or more processors processes data". There is no requirement that the same processor both (i) receive data and (ii) process data. Rather, each of the steps ("receive" and "process") may be performed by different processors.

What is claimed is:

1. A method for managing transactions, the method comprising:
detecting a user interaction on visual content displayed on a digital display;
identifying whether the user interaction occurred within:
a visual interactive area associated with a visual component of the visual content; or
an audio interactive area associated with an auditory component of the visual content;
selecting a beneficiary based on whether the user interaction occurred within the visual interactive area or the audio interactive area;
generating a transaction in response to the user interaction, wherein the transaction is associated with a monetary value and the beneficiary; and
displaying a visual confirmation on the digital display overlaid on the visual content.

2. The method of claim 1, further comprising:
adding the transaction to a transaction queue, wherein the transaction queue is configured to hold a plurality of pending transactions prior to financial commitment;
receiving a confirmation input to commit the transaction queue; and
initiating a financial transfer for an aggregated value of the plurality of pending transactions held in the transaction queue.

3. The method of claim 2, further comprising:
determining splits for the plurality of pending transactions, wherein the splits allocate a first portion of the monetary value to a content creator and a second portion of the monetary value to a charitable organization; and
generating distinct tracking records for the first portion and the second portion.

4. The method of claim 3, further comprising:
publishing the distinct tracking records to a blockchain ledger utilizing a utility token;
scanning the blockchain ledger to retrieve the distinct tracking records; and
generating a public leaderboard based on the distinct tracking records retrieved from the blockchain ledger.

5. The method of claim 4, further comprising:
anonymizing a user identifier associated with the distinct tracking records prior to publishing to the blockchain ledger based on a privacy setting associated with a user.

6. The method of claim 1, further comprising:
retrieving a product identifier associated with a coordinate location of the user interaction; and
setting the monetary value based on a fixed price associated with the product identifier.

7. The method of claim 1, further comprising:
assigning a temporary guest identifier prior to generating the transaction; and
merging the transaction with a registered user account upon a subsequent authentication.

8. An information handling system comprising:
a processor; and
a memory communicatively coupled to the processor, the memory storing instructions which, when executed by the processor, cause the processor to:
detect a user interaction within a visual interactive area defined on a digital display while content data is being presented;
generate, in response to the user interaction, transaction data comprising a transaction identifier and an amount;
assign a pending status to the transaction data; and
generate a visual confirmation of the user interaction for display on the digital display, wherein the visual confirmation is superimposed over the content data without interrupting a playback of the content data.

9. The information handling system of claim 8, wherein the instructions further cause the processor to:
store the transaction data in a pending transaction dashboard, wherein the pending transaction dashboard accumulates a plurality of transaction data without executing a financial settlement;
receive a commit command associated with the pending transaction dashboard;
execute the financial settlement for the transaction data stored in the pending transaction dashboard in response to the commit command;
calculate a total settlement amount by aggregating the amount associated with each of the plurality of transaction data stored in the pending transaction dashboard; and
transmit the total settlement amount to a payment processor as a single financial charge.

10. The information handling system of claim 9, wherein the instructions further cause the processor to:
identify a recipient identifier associated with the transaction data, wherein the recipient identifier designates a content creator or a charitable organization;
generate a blockchain transaction record corresponding to the transaction data, wherein the blockchain transaction record comprises the amount and the recipient identifier; and
publish the blockchain transaction record to a distributed ledger using a utility token, wherein the utility token represents the amount for transparency purposes distinct from the financial settlement.

11. The information handling system of claim 10, wherein the instructions further cause the processor to:
scan the distributed ledger to detect the blockchain transaction record; and
update a leaderboard database based on the blockchain transaction record scanned from the distributed ledger.

12. The information handling system of claim 8, wherein the instructions further cause the processor to:
detect a subsequent user interaction within the visual interactive area;
determine if the subsequent user interaction occurs within a time threshold of the user interaction; and
increase the amount associated with the subsequent user interaction relative to the transaction data if the subsequent user interaction occurs within the time threshold.

13. The information handling system of claim 8, wherein the user interaction comprises a multi-touch gesture, and the instructions further cause the processor to:
determine a quantity of contacts associated with the multi-touch gesture; and
set the amount for the transaction data based on the quantity of contacts.

14. The information handling system of claim 8, wherein the content data comprises a video stream, and wherein the instructions further cause the processor to:
track a movement of a specific object within the video stream; and
dynamically adjust boundaries of the visual interactive area to correspond to the movement of the specific object.

15. An information handling system comprising:
a network interface; and
a processor communicatively coupled to the network interface, wherein the processor is configured to:
receive confirmed transaction data comprising a plurality of individual transactions initiated by a user during a content consumption session;
calculate an aggregate total of the plurality of individual transactions;
transmit the aggregate total to a payment processor for a single financial settlement;
generate a plurality of blockchain transaction records corresponding to the plurality of individual transactions, wherein each of the plurality of blockchain transaction records utilizes a utility token to represent a value of a corresponding individual transaction; and
publish the plurality of blockchain transaction records to a distributed ledger.

16. The information handling system of claim 15, wherein the processor is further configured to:
scan the distributed ledger to identify the plurality of blockchain transaction records;
filter the plurality of blockchain transaction records based on a relevance protocol; and
update a leaderboard system using data extracted from the plurality of blockchain transaction records.

17. The information handling system of claim 15, wherein the processor is further configured to:
parse a specific transaction of the plurality of individual transactions into a tip portion and a donation portion;
generate a first blockchain transaction record for the tip portion directed to a content creator; and
generate a second blockchain transaction record for the donation portion directed to a charitable organization.

18. The information handling system of claim 15, wherein the utility token is a tracking unit denominated in a fiat currency but possessing no inherent tradeable value.

19. The information handling system of claim 15, wherein the processor is further configured to:
check a privacy preference associated with the user; and
replace a user identifier in the plurality of blockchain transaction records with an anonymized string if the privacy preference indicates anonymity.

20. The information handling system of claim 15, wherein the processor is further configured to:
receive a signal indicating a user interaction with a dynamic product interactive area tracking an object moving within a video; and
assign a fixed product price to a specific transaction of the plurality of individual transactions based on the signal.
